(19) United States
(12) Patent Application Publication
(10) Pub. No.: US 2025/0370222 A1
(43) Pub. Date: Dec. 4, 2025

(54) CAMERA OPTICAL LENS

(71) Applicant: AAC OPTICS (CHANGZHOU) CO., LTD., Changzhou (CN)

(72) Inventors: Ke Yang, Changzhou (CN); Shunda Zhou, Changzhou (CN)

(21) Appl. No.: 18/979,506

(22) Filed: Dec. 12, 2024

Related U.S. Application Data
(63) Continuation of application No. PCT/CN2024/096011, filed on May 29, 2024.

(51) Int. Cl. G02B 13/00; G02B 9/64

(52) U.S. Cl. CPC G02B 13/0045; G02B 9/64

(57) ABSTRACT

A camera optical lens sequentially includes seven lenses: a first lens having negative refractive power, a second lens having negative refractive power, a third lens having refractive power, a fourth lens having positive refractive power, a fifth lens having positive refractive power, a sixth lens having positive refractive power, and a seventh lens having negative refractive power. Following relational expressions are satisfied: 1.50≤f4/f5≤3.40; 0.90≤R5/R6≤1.40; 170≤FOV/Fno≤200. The camera optical lens according to the present disclosure has excellent optical characteristics of sufficient aberration correction, large aperture, wide-angle and ultra-thinness, and is particularly suitable for a mobile phone camera lens assembly and a WEB camera lens which are composed of camera elements such as CCD, CMOS with high definition, and a vehicle-mounted lens.

### CROSS-REFERENCE TO RELATED APPLICATIONS

This application is a continuation of International Application No. PCT/CN2024/096011, filed on May 29, 2024, which is hereby incorporated by reference in its entirety.

### TECHNICAL FIELD

The present disclosure relates to the field of optical lens and, in particular to a camera optical lens applicable to handheld terminal devices such as smart phones, digital cameras, and camera devices such as monitors and PC lenses, vehicle-mounted lenses.

### BACKGROUND

In recent years, with the popularity of various smart devices, the demand for a miniaturized camera optical lens has gradually increased. Moreover, since the pixel size of the optical sensor is reduced, and the current electronic product has a light-thin and portable development trend, the miniaturized camera optical lens with good imaging quality has become the mainstream of the current market. In order to obtain better imaging quality, a multi-lens structure is mostly used. In addition, with the development of technology and the increase of diversified requirements of users, under the condition that the pixel area of the optical sensor is continuously reduced and the requirements on the imaging quality of the system are continuously improved, the seven-lens structure gradually appears in the lens design. There is an urgent need for a wide-angle camera lens having excellent optical characteristics such as large aperture, wide-angle, ultra-thinness and sufficiently corrected aberration.

### SUMMARY

In view of the above problems, an object of the present disclosure is to provide a camera optical lens, which has good optical performance and meets design requirements of sufficient aberration correction, large aperture, wide-angle and ultra-thinness.

In order to realize the above object, the technical solution of the present disclosure provides a camera optical lens sequentially includes seven lenses from an object side to an image side: a first lens having negative refractive power, a second lens having negative refractive power, a third lens having refractive power, a fourth lens having positive refractive power, a fifth lens having positive refractive power, a sixth lens having positive refractive power, and a seventh lens having negative refractive power. A focal length of the fourth lens is f4, a focal length of the fifth lens is f5, a central curvature radius of an object side surface of the third lens in a paraxial region is R5, a central curvature radius of an image side surface of the third lens in the paraxial region is R6, a field of view of 1.0 field of view of the camera optical lens is FOV, and an aperture value of the camera optical lens is Fno, and following relational expressions are satisfied:

$$1.5 \leq f 4 / f 5 \leq 3.4 ; \\ 0.9 \leq R 5 / R 6 \leq 1.4 ; \\ and \\ 1 70. \leq FOV / Fno \leq 200.00 .$$

As an improvement, an abbe number of the sixth lens is v6, and an abbe number of the seventh lens is v7, and a following relational expression is satisfied:

$$v 6 - v 7 \geq 35. .$$

As an improvement, an on-axis distance from an image side surface of the seventh lens to an image plane is BF; a total optical length from an object side surface of the first lens to an image plane of the camera optical lens along an optic axis is TTL, and a following relational expression is satisfied:

$$0.09 \leq BF / TTL \leq 0.15 .$$

As an improvement, a focal length of the second lens is f2, an on-axis thickness of the second lens is d3, and a following relational expression is satisfied:

$$8.8 \leq \vert f 2 / d 3 \vert \leq 13. .$$

As an improvement, an object side surface of the first lens is convex in a paraxial region, and an image side surface of the first lens is concave in the paraxial region;

a focal length of the camera optical lens is f, a focal length of the first lens is f1, a central curvature radius of the object side surface of the first lens in a paraxial region is R1, a central curvature radius of the image side surface of the first lens in the paraxial region is R2, an on-axis thickness of the first lens is d1, and the total optical length from the object side surface of the first lens to an image plane of the camera optical lens along an optic axis is TTL, and following relations are satisfied:

$$- 13.18 \leq f 1 / f \leq - 3.84 ; \\ 0.75 \leq ( R 1 + R 2 ) / ( R 1 - R 2 ) \leq 2.64 ; \\ and \\ 0.02 \leq d 1 / TTL \leq 0.24 .$$

As an improvement, an object side surface of the second lens is concave in a paraxial region, and an image side surface of the second lens is concave in the paraxial region; the focal length of the camera optical lens is f, a focal length of the second lens is f2, a central curvature radius of an object side surface of the second lens in a paraxial region is R3, a central curvature radius of an image side surface of the second lens in the paraxial region is R4, an on-axis thickness of the second lens is d3, and the total optical length from the object side surface of the first lens to an image plane of the camera optical lens along an optic axis is TTL, and following relational expressions are satisfied:

$$- 7.57 \leq f 2 / f \leq - 2 \text{.15} ; \\ 0. 21 \leq ( R 3 + R 4 ) / ( R 3 - R 4 ) \leq 0.74 ; \\ and \\ 0.01 \leq d 3 / TTL \leq 0.04 .$$

As an improvement, the object side surface of the third lens is concave in a paraxial region, and an image side surface of the third lens is convex in the paraxial region;
the focal length of the camera optical lens is f, a focal length of the third lens is f3, an on-axis thickness of the third lens is d5, and the total optical length from the object side surface of the first lens to an image plane of the camera optical lens along an optic axis is TTL, and following relational expressions are satisfied:

$$- 3 743.34 \leq f 3 / f \leq 88.1 ; \\ - 39.92 \leq ( R 5 + R 6 ) / ( R 5 - R 6 ) \leq 18.19 ; \\ 0.07 \leq d 5 / TTL \leq 0.25 .$$

As an improvement, an object side surface of the fourth lens is concave in a paraxial region, and an image side surface of the fourth lens is convex in the paraxial region;
the focal length of the camera optical lens is f, a central curvature radius of an object side surface of the fourth lens in a paraxial region is R7, a central curvature radius of an image side surface of the fourth lens in the paraxial region is R8, an on-axis thickness of the fourth lens is d7, and the total optical length from the object side surface of the first lens to an image plane of the camera optical lens along an optic axis is TTL, and the following relational expressions are satisfied:

$$2.45 \leq f 4 / f \leq 14.08 ; \\ 0.72 \leq ( R 7 + R 8 ) / ( R 7 - R 8 ) \leq 3.62 ; \\ and \\ 0.03 \leq d 7 / TTL \leq 0.15 .$$

As an improvement, an object side surface of the fifth lens is convex in a paraxial region, an image side surface of the fifth lens is convex in the paraxial region;
a focal length of the camera optical lens is f, a central curvature radius of an object side surface of the fifth lens in a paraxial region is R9, a central curvature radius of an image side surface of the fifth lens in the paraxial region is R10, an on-axis thickness of the fifth lens is d9, and a total optical length from the object side surface of the first lens to an image plane of the camera optical lens along an optic axis is TTL, and following relational expressions are satisfied:

$$1.29 \leq f 5 / f \leq 4.85 ; \\ 0.03 \leq ( R 9 + R 10 ) / ( R 9 - R 10 ) \leq 0.33 ; \\ and \\ 0. 04 \leq d 9 / TTL \leq 0.19 .$$

As an improvement, the first lens is made of glass.

The present disclosure has the following beneficial effects: the camera optical lens according to the present disclosure has excellent optical characteristics of sufficient aberration correction, large aperture, wide-angle and ultra-thinness, and is particularly suitable for a mobile phone camera lens assembly and a WEB camera lens which are composed of camera elements such as CCD, CMOS with high definition, and a vehicle-mounted lens.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Example 1 of the present disclosure; FIG. 2 is a schematic diagram of longitudinal aberration of the camera optical lens

shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens according to Example 5 of the present disclosure;

FIG. 18 is a schematic diagram of longitudinal aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a structural schematic diagram of a camera optical lens according to Example 6 of the present disclosure;

FIG. 22 is a schematic diagram of longitudinal aberration of the camera optical lens shown in FIG. 21;

FIG. 23 is a schematic diagram of lateral color of the camera optical lens shown in FIG. 21;

FIG. 24 is a schematic diagram of field curvature and distortion of the camera optical lens shown in FIG. 21.

FIG. 25 is a structural schematic diagram of a camera optical lens according to Example 7 of the present disclosure;

FIG. 26 is a schematic diagram of longitudinal aberration of the camera optical lens shown in FIG. 25;

FIG. 27 is a schematic diagram of lateral color of the camera optical lens shown in FIG. 25;

FIG. 28 is a schematic diagram of field curvature and distortion of the camera optical lens shown in FIG. 25.

FIG. 29 is a schematic structural diagram of a camera optical lens according to Comparative Example;

FIG. 30 is a schematic diagram of longitudinal aberration of the camera optical lens shown in FIG. 29;

FIG. 31 is a schematic diagram of lateral color of the camera optical lens shown in FIG. 29; and

FIG. 32 is a schematic diagram of field curvature and distortion of the camera optical lens shown in FIG. 29.

### DESCRIPTION OF EMBODIMENTS

In order to more clearly illustrate objectives, technical solutions, and advantages of the embodiments of the present disclosure, the technical solutions in the embodiments of the present disclosure are clearly and completely described in details with reference to the drawings. However, those of ordinary skill in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

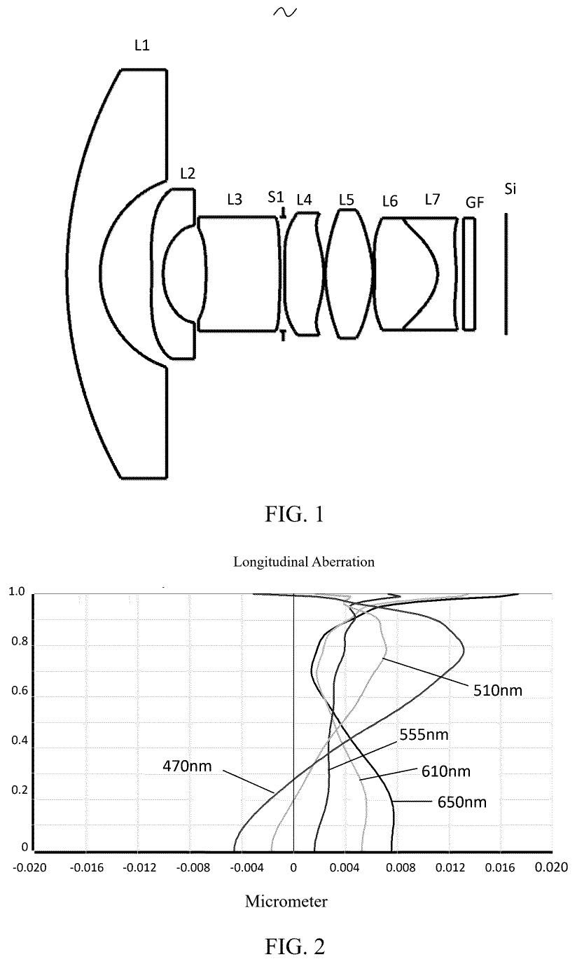

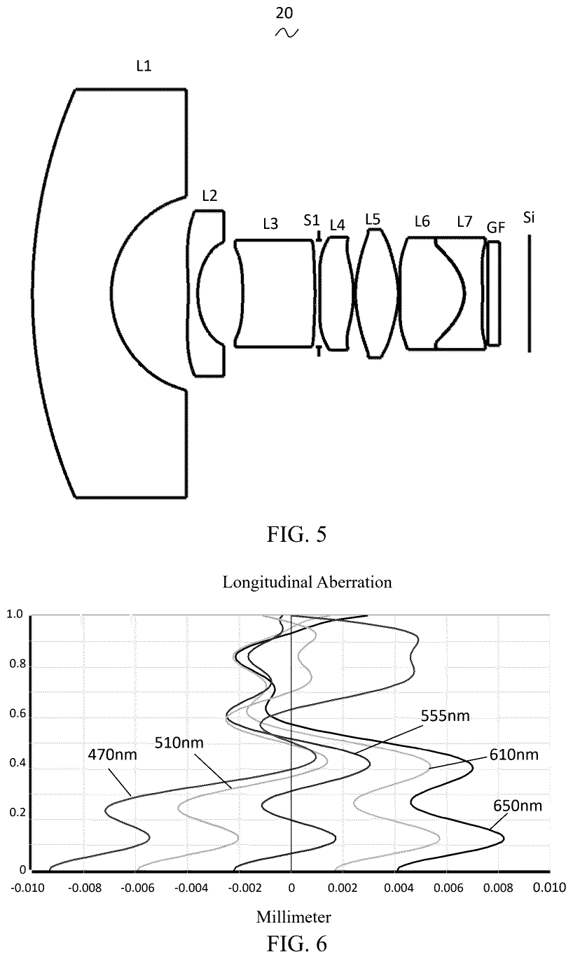

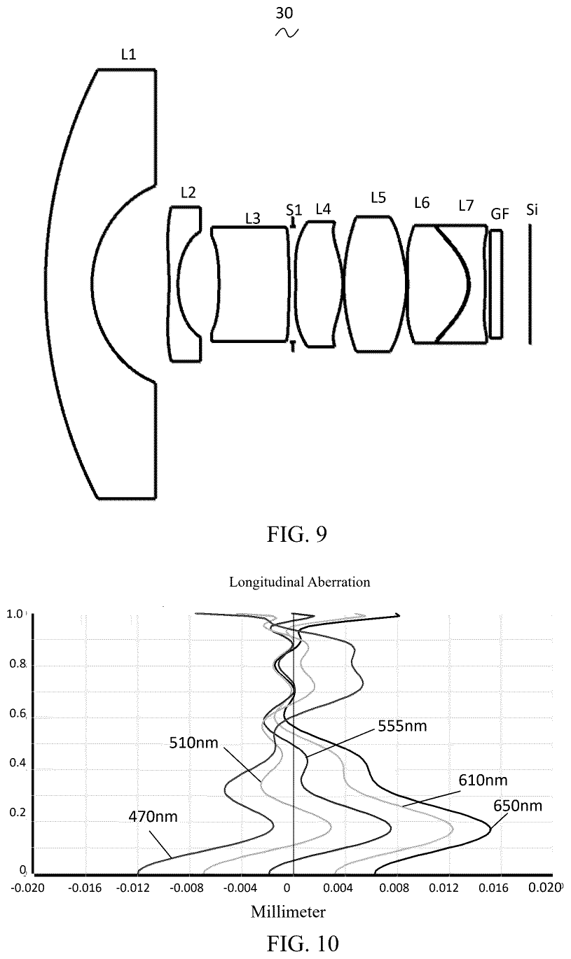

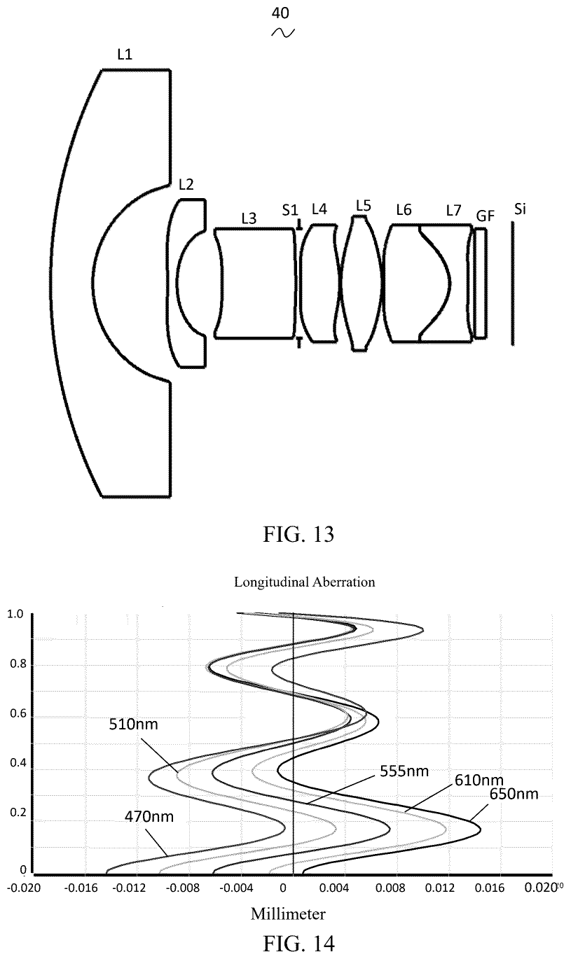

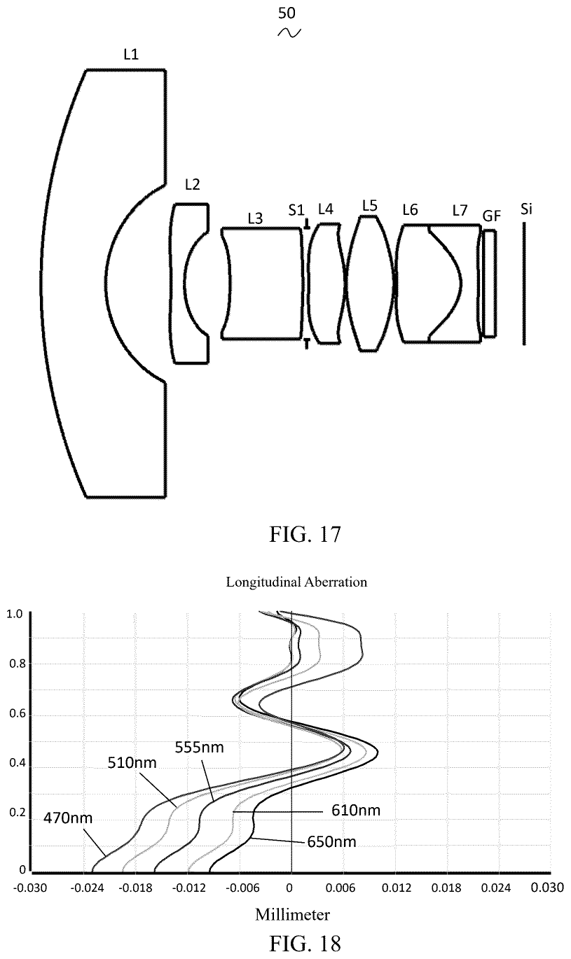

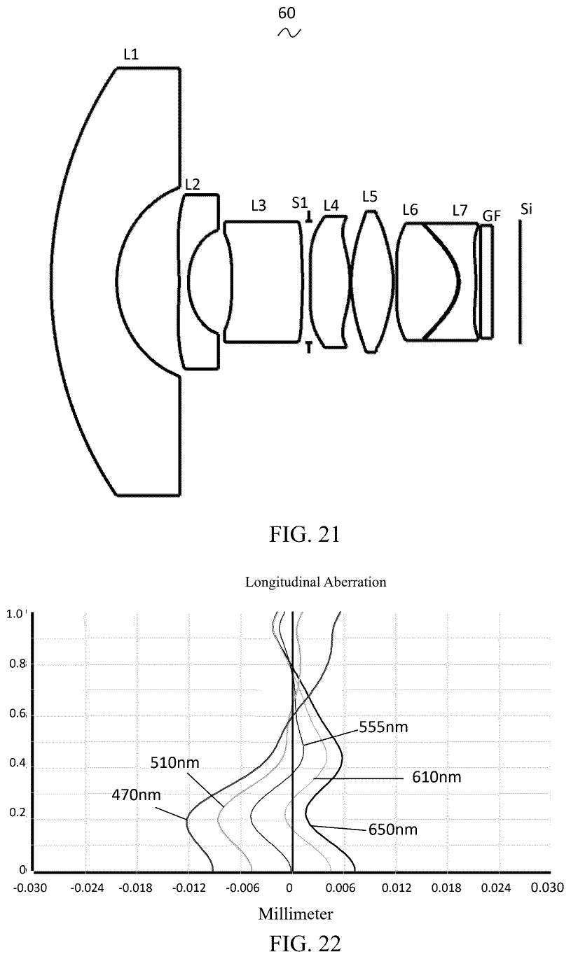

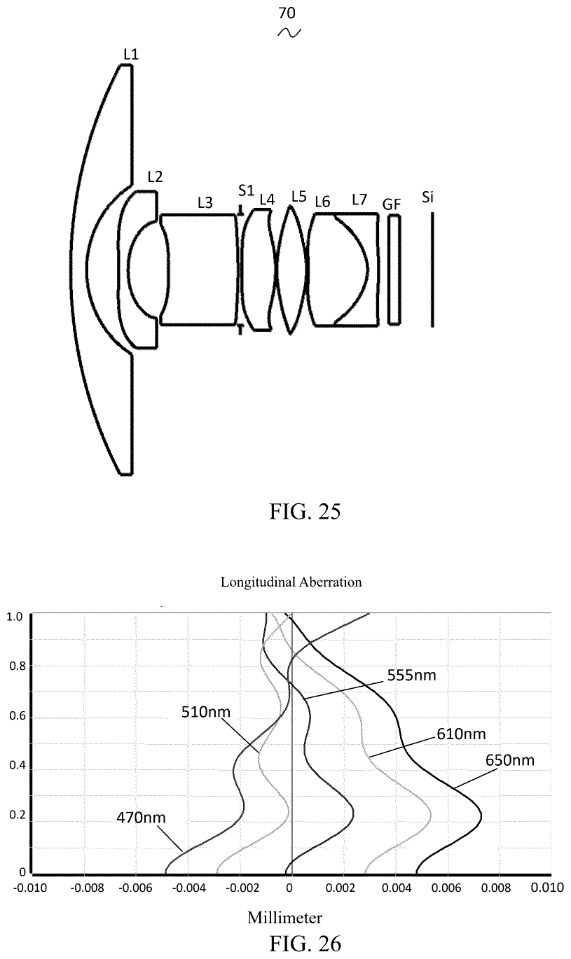

Referring to FIGS. 1-28, the technical solution of the present disclosure provides camera optical lenses 10, 20, 30, 40, 50, 60 and 70. FIG. 1, FIG. 5, FIG. 9, FIG. 13, FIG. 17, FIG. 21 and FIG. 25 show camera optical lenses 10, 20, 30, 40, 50, 60 and 70 according to the present disclosure, and the camera optical lenses 10, 20, 30, 40, 50, 60 and 70 include seven lenses. The camera optical lens sequentially includes from an object side to an image side: a first lens L1, a second lens L2, a third lens L3, an aperture S1, a fourth lens L4, a fifth lens L5, a sixth lens L6 and a seventh lens L7. An optical element such as a grating filter may be provided between the seventh lens L7 and an image surface Si.

The first lens L1 is made of glass, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. The glass and the resin lens are matched to reduce chromatic aberration and improve the performance of the optical camera lens. The lenses may also be made of other materials.

A focal length of the fourth lens L4 is defined as f4, a focal length of the fifth lens L5 is defined as f5, and a following relational expression is satisfied: 1.50≤f4/f5≤3.40. It defines a ratio of the focal length of the fourth lens to the focal length of the fifth lens. Within the above range of the relational expression, it is helpful for smooth transition of light by reasonably distributing the focal length of the distribution system, so that the system has better imaging quality and lower sensitivity.

A central curvature radius of the object side surface of the third lens L3 is defined as R5 in the paraxial region, a central curvature radius of the image side surface of the third lens L3 is defined as R6 in the paraxial region, and a following relational expression is satisfied: 0.90≤R5/R6≤1.40. It defines a shape of the third lens. Within the above range of the relational expression, the large-angle light deflected after passing through the first lens L1 and the second lens L2 may be effectively alleviated, the field curvature of the system may be effectively balanced, and the field curvature offset of the central field of view is smaller than 0.02 mm.

A field of view of the 1.0 field of view of the camera optical lens is defined as FOV, and an aperture value of the camera optical lens is defined as Fno, and a following relational expression is satisfied: 170.00≤FOV/Fno≤200.00. It defines the range of the ratio of the field of view to the aperture. Within the above range of the relational expression, the ultra-large aperture and ultra-wide-angle are realized, the application requirements are met, and the application range of the product is expanded.

An abbe number of the sixth lens L6 is defined as v6, an abbe number of the seventh lens L7 is defined as v7, and a following relational expression is satisfied: v6−v7≥35.00. It defines the difference between the abbe numbers of the glued lenses. Within the above range of the relational expression, material properties may be effectively distributed, chromatic aberration may be effectively corrected, and the chromatic aberration |LC|≤4 μm.

An on-axis distance from an image side surface of the seventh lens L7 to an image surface Si is defined as BF, and a total optical length from an object side surface of the first lens to an image plane of the camera optical lens along an optic axis is defined as TTL, and a following relational expression is satisfied: 0.09<BF/TTL≤0.15. Within the above range of the relational expression, on the basis of realizing miniaturization, the back focal length is reduced, and it is beneficial to the assembly of the module.

A focal length of the second lens L2 is defined as f2, an on-axis thickness of the second lens L2 is defined as d3, and a following relational expression is satisfied: 8.80≤|f2/d3|≤13.00. Within the above range of the relational expression, it is helpful to buffer the change of the incident angle of the large-view-angle light, so that the large-view-angle light smoothly propagates in the optical imaging lens assembly, while maintaining the refractive power intensity of the second lens, so as to improve the chromatic aberration and improve the imaging quality.

When the above relational expression is satisfied, the camera optical lenses 10, 20,

30, 40, 50, 60 and 70 have good optical performance and may satisfy the design requirements of large aperture and wide-angle; according to the characteristics of the camera optical lenses 10, 20, 30, 40, 50, 60 and 70, the camera optical lenses 10, 20, 30, 40, 50, 60 and 70 are particularly suitable for mobile phone camera lens assemblies and WEB camera lenses composed of camera elements such as CCD and CMOS with high definition.

Based on the above relational expressions and the achievable functions, the characteristics of each lens are further refined as follows.

An object side surface of the first lens L1 is convex in a paraxial region, an image side surface of the first lens L1 is concave in the paraxial region, and the first lens L1 has negative refractive power. The object side surface and the image side surface of the first lens L1 may also be provided with other concave and convex distributions.

A focal length of the camera optical lens is defined as f, a focal length of the first lens L1 is defined as f1, and a following relational expression is satisfied: −13.18≤f1/f≤−3.84. It defines a ratio of a negative refractive power of the first lens L1 to an overall focal length. Within the above range of the relational expression, the first lens L1 has a proper negative refractive power, it is beneficial to reduce the aberration of the system, while it is beneficial to development of the lens assembly to ultra-thinness and wide-angle. Optionally, a following relational expression is satisfied: −8.24≤f1/f≤−4.80.

A central curvature radius of the object side surface of the first lens L1 in a paraxial region is defined as R1, a central curvature radius of the image side surface of the first lens L1 in the paraxial region is defined as R2, and a following relational expression is satisfied: 0.75≤(R1+R2)/(R1−R2)≤2.64. The shape of the first lens L1 is reasonably controlled, so that the first lens L1 may effectively correct the spherical aberration of the system. Optionally, a following relational expression is satisfied: 1.19≤(R1+R2)/(R1−R2)≤2.11.

An on-axis thickness of the first lens L1 is d1, the total optical length from the object side surface of the first lens to an image plane of the camera optical lens along an optic axis of the camera optical lens is TTL, and a following relational expression is satisfied: 0.02≤d1/TTL≤0.24. Within the above range of the relational expression, it is beneficial to achieve miniaturization. Optionally, a following relational expression is satisfied: 0.04≤d1/TTL≤0.19.

An object side surface of the second lens L2 is concave in a paraxial region, an image side surface of the second lens L2 is concave in the paraxial region, and the second lens L2 has negative refractive power. The object side surface and the image side surface of the second lens L2 may also be provided with other concave and convex distributions.

The focal length of the camera optical lens is defined as f, the focal length of the second lens L2 is defined as f2, and a following relational expression is satisfied: −7.57≤f2/f≤−2.15. It is beneficial to correct the aberration of the optical system by the negative refractive power of the second lens L2 is controlled in a reasonable range. Optionally, a following relational expression is satisfied: −4.73≤f2/f≤−2.69.

A central curvature radius of the object side surface of the second lens L2 in a paraxial region is R3, a central curvature radius of the image side surface of the second lens L2 in the paraxial region is R4, and the relational expression is satisfied: 0.21≤ (R3+R4)/(R3−R4) ≤0.74. It defines the shape of the second lens L2. Within the above range of the relational expression, it is beneficial to correct problems such as on-axis chromatic aberration with development of ultra-thinness and wide-angle lenses. Optionally, a following relational expression is satisfied: 0.34≤ (R3+R4)/(R3-R4) ≤0.60.

An on-axis thickness of the second lens L2 is d3, the total optical length from the object side surface of the first lens to an image plane of the camera optical lens along an optic axis is TTL. 0.01≤d3/TTL≤0.04. Within the above range of the relational expression, it is beneficial to achieve miniaturization. Optionally, a following relational expression is satisfied:

0.01≤d3/TTL≤0.03.

An object side surface of the third lens L3 is concave in the paraxial region, an image side surface of the third lens L3 is convex in the paraxial region, and the third lens L3 has a positive refractive power or a negative refractive power. The object side surface and the image side surface of the third lens L3 may also be provided with other concave and convex distributions.

The focal length of the camera optical lens is defined as f, a focal length of the third lens L3 is defined as f3, and a following relational expression is satisfied: −3743.34≤f3/f<88.10. The system has better imaging quality and lower sensitivity by reasonable distributing the refractive power. Optionally, a following relational expression is satisfied: −2339.59≤f3/f≤70.48.

A central curvature radius of the object side surface of the third lens L3 in a paraxial region is defined as R5, a central curvature radius of the image side surface of the third lens L3 in the paraxial region is defined as R6, and a following relational expression is satisfied: −39.92≤(R5+R6)/(R5-R6)≤18.19. Within the above range of the relational expression, the shape of the third lens L3 may be effectively controlled, and it is beneficial for molding of the third lens L3, and molding defects and stress generation caused by excessive surface curvature of the third lens L3 are avoided. Optionally, a following relational expression is satisfied: −24.95≤(R5+R6)/(R5-R6)≤14.55.

An on-axis thickness of the third lens L3 is d5, the total optical length from the object side surface of the first lens to an image plane of the camera optical lens along an optic axis is TTL, and a following relational expression is satisfied: 0.07≤d5/TTL≤0.25. Within the above range of the relational expression, it is beneficial to achieve miniaturization. Optionally, a following relational expression is satisfied: 0.12≤d5/TTL≤0.20.

An object side surface of the fourth lens L4 is concave in a paraxial region, an image side surface of the fourth lens L4 is convex in the paraxial region, and the fourth lens L4 has positive refractive power. The object side surface and the image side surface of the fourth lens L4 may also be provided with other concave and convex distributions.

The focal length of the camera optical lens is defined as f, a focal length of the fourth lens L4 is defined as f4, and a following relational expression is satisfied: 2.45≤f4/f≤14.08. The system has better imaging quality and lower sensitivity by reasonable distributing the refractive power. Optionally, a following relational expression is satisfied: 3.92≤f4/f≤11.27.

A central curvature radius of the object side surface of the fourth lens L4 in a paraxial region is R7, and a central curvature radius of the image side surface of the fourth lens L4 in the paraxial region is R8, and a following relational expression is satisfied: 0.72≤ (R7+R8)/(R7−R8)≤3.62. It defines the shape of the fourth lens L4. Within the above range of the relational expression, it is beneficial to correct the aberration of off-axis chromatic angles with the development of ultra-thinness and wide-angle. Optionally, a following relational expression is satisfied: 1.16≤ (R7+R8)/(R7-R8) ≤2.90.

An on-axis thickness of the fourth lens L4 is d7, the total optical length from the object side surface of the first lens to an image plane of the camera optical lens along an optic axis of the camera optical lens is TTL, and a following relational expression is satisfied: 0.03≤d7/TTL≤0.15. Within the above range of the relational expression, it is beneficial to achieve miniaturization. Optionally, a following relational expression is satisfied: 0.05≤d7/TTL≤0.12.

An object side surface of the fifth lens L5 is convex in a paraxial region, an image side surface of the fifth lens L5 is convex in the paraxial region, and the fifth lens L5 has a positive refractive power. The object side surface and the image side surface of the fifth lens L5 may also be provided with other concave and convex distributions.

The focal length of the camera optical lens is defined as f, a focal length of the fifth lens L5 is defined as f5, and a following relational expression is satisfied: 1.29≤f5/f≤4.85. The limitation of the fifth lens L5 may effectively make a light angle of the camera lens smooth, and reduce tolerance sensitivity. Optionally, a following relational expression is satisfied: 2.06≤f5/f≤3.88.

A central curvature radius of an object side surface of the fifth lens L5 in a paraxial region is defined as R9, a central curvature radius of an image side surface of the fifth lens L5 in the paraxial region is defined as R10, and a following relational expression is satisfied: 0.03≤(R9+R10)/(R9−R10)≤0.33. It defines the shape of the fifth lens L5. Within the above range of the relational expression, it is beneficial to correct the problems such as the aberration of off-axis angles with the development of the ultra-thinness and wide-angle. Optionally, a following relational expression is satisfied: 0.04≤(R9+R10)/(R9−R10)≤0.26.

An on-axis thickness of the fifth lens L5 is d9, the total optical length from the object side surface of the first lens to an image plane of the camera optical lens along an optic axis is TTL, and a following relational expression is satisfied: 0.04≤d9/TTL≤0.19. Within the above range of the relational expression, it is beneficial to achieve miniaturization. Optionally, a following relational expression is satisfied: 0.07≤d9/TTL≤0.16.

An object side surface of the sixth lens L6 is concave in the paraxial region, an image side surface of the sixth lens L6 is convex in the paraxial region, and the sixth lens L6 has positive refractive power. The object side surface and the image side surface of the sixth lens L6 may also be provided with other concave and convex distributions.

A focal length of the camera optical lens is defined as f, and a focal length of the sixth lens L6 is defined as f6, and a following relational expression is satisfied: 0.86≤f6/f≤2.89. The system has better imaging quality and lower sensitivity by reasonable distributing the refractive power. Optionally, a following relational expression is satisfied: 1.38≤f6/f<2.31.

A central curvature radius of the object side surface of the sixth lens L6 in a paraxial region is R11, a central curvature radius of the image side surface of the sixth lens L6 in the paraxial region is R12, and a following relational expression is satisfied: 0.59≤(R11+R12)/(R11−R12)≤1.93. It defines the shape of the sixth lens L6. Within the above range of the relational expression, it is beneficial to correct the problems such as the aberration of off-axis angles with the development of the ultra-thinness and wide-angle. Optionally, a following relational expression is satisfied: 0.94≤ (R11+R12)/(R11-R12) ≤1.54.

An on-axis thickness of the sixth lens L6 is d11, a total optical length from an object side surface of the first lens to an image plane of the camera optical lens along an optic axis of the camera optical lens 10 is TTL, and a following relational expression is satisfied: 0.06≤d11/TTL≤0.22. Within the above range of the relational expression, it is beneficial to achieve miniaturization. Optionally, a following relational expression is satisfied: 0.10≤d11/TTL≤0.17.

An object side surface of the seventh lens L7 is concave in the paraxial region, an image side surface of the seventh lens L7 is convex in the paraxial region, and the seventh lens L7 has negative refractive power. The object side surface and the image side surface of the sixth lens L6 may also be provided with other concave and convex distributions.

The focal length of the camera optical lens is defined as f, a focal length of the seventh lens L7 is defined as f7, and a following relational expression is satisfied: −4.26≤f7/f≤−1.22. The system has better imaging quality and lower sensitivity by reasonable distributing the refractive power. Optionally, a following relational expression is satisfied: −2.66≤f7/f≤−1.52.

A central curvature radius of the object side surface of the seventh lens L7 in a paraxial region is defined as R13, a central curvature radius of the image side surface of the seventh lens L7 in the paraxial region is defined as R14, and a following relational expression is satisfied: −3.05≤(R13+R14)/(R13−R14)≤−0.98. It defines the shape of the seventh lens L7. Within the above range of the relational expression, it is beneficial to correct the problems such as the aberration of off-axis angles with the development of the ultra-thinness and wide-angle. Optionally, a following relational expression is satisfied: −1.91≤(R13+R14)/(R13−R14)≤−1.23.

An on-axis thickness of the seventh lens L7 is d13, the total optical length from the object side surface of the first lens to an image plane of the camera optical lens along an optic axis of the optical camera lens 10 is TTL, and a following relational expression is satisfied: 0.02≤d13/TTL≤0.06. Within the above range of the relational expression, it is beneficial to achieve miniaturization. Optionally, a following relational expression is satisfied: 0.02≤d13/TTL≤0.05.

A field of view FOV of the camera optical lens is greater than or equal to 197.00°, thereby achieving wide-angle.

An F-number FNO of the camera optical lens 10 is smaller than or equal to 1.10, thereby achieving a large aperture and good imaging performance of the camera optical lens.

The camera optical lens of the present disclosure will be described below with embodiments. The reference signs recited in each embodiments are shown below. The units of focal length, on-axis distance, central curvature radius and on-axis thickness are mm. TTL: a total optical length (on-axis distance from an object side surface of the first lens L1 to an image plane Si of the camera optical lens along an optic axis) is in mm; F-number FNO refers to the ratio of the effective focal length of the camera optical lens to the entrance pupil diameter of the camera optical lens.

The technical solutions of the present disclosure will be described in detail in seven examples and one Comparative Example.

### EXAMPLE 1

Table 1 and Table 2 show design data of the camera optical lens 10 according to Example 1 of the present disclosure.

TABLE 1

| | R | d | | nd | | νd | |
|---|---|---|---|---|---|---|---|
| S1 | ∞ | d0= | −3.879 | | | | |
| R1 | 7.350 | d1= | 0.600 | nd1 | 1.6516 | ν1 | 58.42 |
| R2 | 1.769 | d2= | 0.925 | | | | |
| R3 | −4.516 | d3= | 0.205 | nd2 | 1.5365 | ν2 | 55.98 |
| R4 | 1.519 | d4= | 0.767 | | | | |
| R5 | −7.099 | d5= | 1.330 | nd3 | 1.6610 | ν3 | 20.53 |
| R6 | −5.578 | d6= | 0.082 | | | | |
| R7 | −6.383 | d7= | 0.698 | nd4 | 1.5365 | ν4 | 55.98 |
| R8 | −1.812 | d8= | 0.030 | | | | |
| R9 | 1.967 | d9= | 0.852 | nd5 | 1.5365 | ν5 | 55.98 |
| R10 | −1.609 | d10= | 0.030 | | | | |
| R11 | −6.450 | d11= | 1.130 | nd6 | 1.5365 | ν6 | 55.98 |
| R12 | −0.603 | d12= | 0.000 | | | | |
| R13 | −0.603 | d13= | 0.333 | nd7 | 1.6610 | ν7 | 20.53 |
| R14 | −3.157 | d14= | 0.126 | | | | |
| R15 | ∞ | d15= | 0.210 | ndg | 1.5168 | νg | 64.17 |
| R16 | ∞ | d16= | 0.554 | | | | |

The meaning of each reference sign is as follows.
S1: aperture;
R: curvature radius at the center of the optical surface;
R1: central curvature radius of the object side surface of the first lens L1 in the paraxial region;
R2: central curvature radius of the image side surface of the first lens L1 in the paraxial region;
R3: central curvature radius of the object side surface of the second lens L2 in the paraxial region;
R4: central curvature radius of the image side surface of the second lens L2 in the paraxial region;
R5: central curvature radius of the object side surface of the third lens L3 in the paraxial region;
R6: central curvature radius of the image side surface of the third lens L3 in the paraxial region;
R7: central curvature radius of the object side surface of the fourth lens L4 in the paraxial region;
R8: central curvature radius of the image side surface of the fourth lens L4 in the paraxial region;
R9: central curvature radius of the object side surface of the fifth lens L5 in the paraxial region;
R10: central curvature radius of the image side surface of the fifth lens L5 in the paraxial region;
R11: central curvature radius of the object side surface of the sixth lens L6 in the paraxial region;
R12: central curvature radius of the image side surface of the sixth lens L6 in the paraxial region;
R13: central curvature radius of the object side surface of the seventh lens L7 in the paraxial region;
R14: central curvature radius of the image side surface of the seventh lens L7 in the paraxial region;
R15: central curvature radius of the object side surface of the grating filter GF in the paraxial region;
R16: central curvature radius of the image side surface of the grating filter GF in the paraxial region;
d: on-axis thickness of lenses, on-axis distance between lenses;
d0: on-axis distance from aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the sixth lens L6;
d11: on-axis thickness of the sixth lens L6;
d12: on-axis distance from the image side surface of the sixth lens L6 to the object side surface of the seventh lens L7;
d13: on-axis thickness of the seventh lens L7;
d14: on-axis distance from the image side surface of the seventh lens L7 to the object side surface of the grating filter GF;
d15: on-axis thickness of the grating filter GF;
d16: on-axis distance from the image side surface of the grating filter GF to the image plane Si;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
nd7: refractive index of d line of the seventh lens L7;
ndg: refractive index of d line of grating filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
v6: abbe number of the sixth lens L6;
v7: abbe number of the seventh lens L7;
vg: abbe number of the grating filter GF.

Table 2 shows aspherical surface data of each lens in the camera optical lens 10 according to Example 1 of the present disclosure.

TABLE 2

| | Conic Coefficient | Aspherical Coefficient | | | | |
|---|---|---|---|---|---|---|
| | k | A4 | A6 | A8 | A10 | A12 |
| R3 | −1.6801E+02 | 3.2264E−01 | −7.3753E−01 | 1.2977E+00 | −1.5656E+00 | 1.2901E+00 |
| R4 | 2.0071E+00 | 3.5670E−01 | 9.4690E−01 | −1.6561E+01 | 8.8807E+01 | −2.7214E+02 |
| R5 | 9.9251E+00 | −1.3111E−01 | −5.4221E−01 | 3.6371E+00 | −1.6156E+01 | 4.4971E+01 |
| R6 | 2.3597E+01 | 1.5958E−01 | 8.9760E−02 | −1.6531E+00 | 5.6701E+00 | −1.0809E+01 |
| R7 | −1.1225E+02 | 3.8438E−01 | −1.4149E−01 | −1.2349E+00 | 4.9721E+00 | −9.7171E+00 |
| R8 | −2.1508E+00 | 5.0417E−02 | 4.6403E−02 | −2.6378E−01 | 1.6331E+00 | −3.9607E+00 |
| R9 | −1.5959E+01 | 1.1222E−01 | −3.7593E−01 | 5.9175E−01 | −2.4631E−02 | −1.2530E+00 |
| R10 | −5.5370E+00 | 4.3799E−02 | 3.1877E−02 | −2.6636E−01 | 7.8251E−01 | −1.4568E+00 |
| R11 | −1.5663E+02 | 2.2873E−01 | 2.0643E−01 | −9.7165E−01 | 2.2866E+00 | −3.6445E+00 |
| R12 | −6.8875E−01 | 9.7367E−01 | −3.6023E+00 | 1.3770E+01 | −4.0254E+01 | 8.4245E+01 |
| R13 | −6.8875E−01 | 9.7367E−01 | −3.6023E+00 | 1.3770E+01 | −4.0254E+01 | 8.4245E+01 |
| R14 | −2.0000E+02 | −2.2380E−01 | 1.7111E+00 | −6.1014E+00 | 1.5458E+01 | −2.7174E+01 |

| | Conic Coefficient | Aspherical Coefficient | | | |
|---|---|---|---|---|---|
| | k | A14 | A16 | A18 | A20 |
| R3 | −1.6801E+02 | −7.0854E−01 | 2.4740E−01 | −4.9589E−02 | 4.3445E−03 |
| R4 | 2.0071E+00 | 5.1515E+02 | −5.9464E+02 | 3.8383E+02 | −1.0623E+02 |
| R5 | 9.9251E+00 | −7.7105E+01 | 7.8162E+01 | −4.2218E+01 | 9.0582E+00 |
| R6 | 2.3597E+01 | 1.2444E+01 | −8.6138E+00 | 3.2981E+00 | −5.3222E−01 |
| R7 | −1.1225E+02 | 1.1327E+01 | −7.9998E+00 | 3.1704E+00 | −5.4377E−01 |
| R8 | −2.1508E+00 | 5.5181E+00 | −4.4766E+00 | 1.9506E+00 | −3.5571E−01 |
| R9 | −1.5959E+01 | 2.0451E+00 | −1.5997E+00 | 6.4070E−01 | −1.0458E−01 |
| R10 | −5.5370E+00 | 1.6086E+00 | −1.0503E+00 | 3.7707E−01 | −5.7200E−02 |
| R11 | −1.5663E+02 | 3.5504E+00 | −1.9007E+00 | 4.2191E−01 | 0.0000E+00 |
| R12 | −6.8875E−01 | −1.1603E+02 | 9.9713E+01 | −4.8423E+01 | 1.0182E+01 |
| R13 | −6.8875E−01 | −1.1603E+02 | 9.9713E+01 | −4.8423E+01 | 1.0182E+01 |
| R14 | −2.0000E+02 | 3.2552E+01 | −2.5271E+01 | 1.1376E+01 | −2.2408E+00 |

For convenience, the aspherical surface of each lens surface uses the aspherical surface shown in the following formula (1). However, the present disclosure is not limited to the aspherical polynomial form shown in formula (1).

$$z = ( cr 2 ) / \{ 1 + [ 1 - ( k + 1 ) ( c 2 r 2 ) ] 1 / 2 \} + A 4 r 4 + A 6 r 6 + A 8 r 8 + A 10 r 10 + A 12 r 12 + A 14 r 14 + A 16 r 16 + A 18 r 18 + A 20 r 20 \qquad ( 1 )$$

Where, k is a conic coefficient, A4, A6, A8, A10, A12, A14, A16, A18, and A20 are aspherical coefficients, c is a curvature at a center of an optical surface, r is a vertical distance between a point on an aspherical curve and an optical axis, and z is an aspherical depth (a vertical distance between a point on the aspherical surface having a distance r from the optical axis, and a tangent plane tangent to a vertex on the aspherical optical axis).

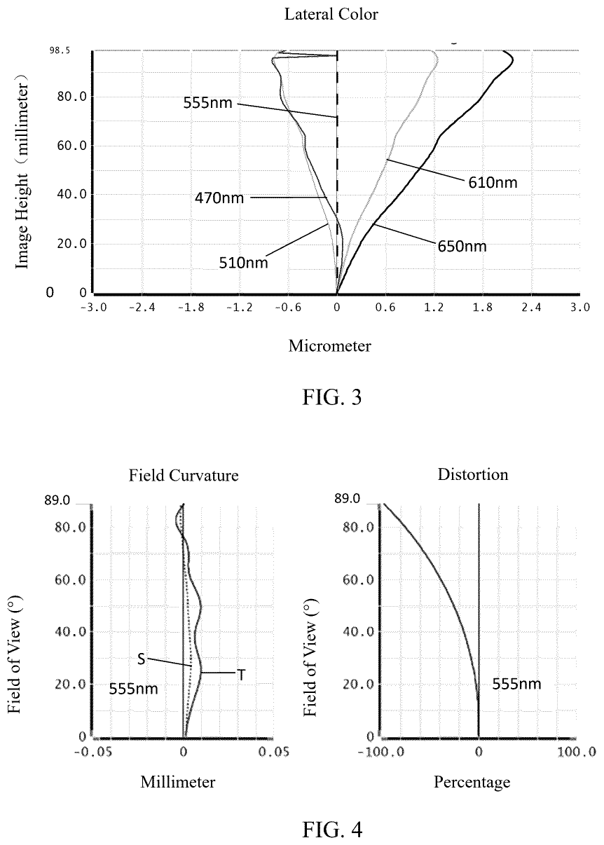

FIG. 2 and FIG. 3 respectively show longitudinal aberration and lateral color of light with wavelengths of 650 nm, 610 nm, 555 nm, 510 nm, and 470 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in the sagittal direction, and T is a field curvature in the meridian direction.

In this example, an entrance pupil diameter ENPD of the camera optical lens 10 is 0.628 mm, a full field of view (1.0 field of view) image height IH is 1.088 mm, and a field of view FOV in a diagonal direction of the full field of view (1.0 field of view) is 197.00°. The camera optical lens 10 meets the design requirements of large aperture, wide-angle and ultra-thinness, its on-axis and off-axis chromatic aberrations are fully corrected. The camera optical lens 10 has excellent optical characteristics.

It may be understood that the 1.0 field of view image height refers to half of the diagonal length of an effective pixel area of the sensor; the FOV in the diagonal direction of the 1.0 field of view refers to the field of view corresponding to the effective pixel area of the sensor.

### EXAMPLE 2

The meaning of the reference signs of Example 2 is the same as that of Example 1.

FIG. 5 shows a camera optical lens 20 according to Example 2 of the present disclosure.

Table 3 and Table 4 show design data of the camera optical lens 20 according to Example 2 of the present disclosure.

TABLE 3

| | R | d | | nd | | νd | |
|---|---|---|---|---|---|---|---|
| S1 | ∞ | d0= | −5.132 | | | | |
| R1 | 9.092 | d1= | 1.413 | nd1 | 1.6516 | ν1 | 58.42 |
| R2 | 1.794 | d2= | 1.381 | | | | |
| R3 | −4.593 | d3= | 0.168 | nd2 | 1.5365 | ν2 | 55.98 |
| R4 | 1.601 | d4= | 0.806 | | | | |
| R5 | −7.049 | d5= | 1.296 | nd3 | 1.6610 | ν3 | 20.53 |
| R6 | −5.611 | d6= | 0.089 | | | | |
| R7 | −4.617 | d7= | 0.601 | nd4 | 1.5365 | ν4 | 55.98 |
| R8 | −1.913 | d8= | 0.034 | | | | |
| R9 | 1.740 | d9= | 0.768 | nd5 | 1.5365 | ν5 | 55.98 |
| R10 | −1.551 | d10= | 0.034 | | | | |
| R11 | −7.654 | d11= | 1.154 | nd6 | 1.5365 | ν6 | 55.98 |
| R12 | −0.606 | d12= | 0.000 | | | | |
| R13 | −0.606 | d13= | 0.330 | nd7 | 1.6610 | ν7 | 20.53 |
| R14 | −3.122 | d14= | 0.099 | | | | |
| R15 | ∞ | d15= | 0.210 | ndg | 1.5168 | νg | 64.17 |
| R16 | ∞ | d16= | 0.527 | | | | |

Table 4 shows aspherical surface data of each lens in the camera optical lens 20 according to Example 2 of the present disclosure.

TABLE 4

| | Conic Coefficient | Aspherical Coefficient | | | | |
|---|---|---|---|---|---|---|
| | k | A4 | A6 | A8 | A10 | A12 |
| R3 | −1.0828E+02 | 1.9205E−01 | −4.6047E−01 | 8.1419E−01 | −9.4025E−01 | 7.2289E−01 |
| R4 | 1.8413E+00 | −4.0479E−02 | 3.2247E+00 | −2.7203E+01 | 1.1938E+02 | −3.1681E+02 |
| R5 | −3.6797E+00 | 1.3566E−02 | −2.9065E+00 | 2.1901E+01 | −9.8675E+01 | 2.7510E+02 |
| R6 | 2.3240E+01 | 1.4250E−01 | 8.0683E−01 | −8.7403E+00 | 3.7691E+01 | −9.0826E+01 |
| R7 | −1.2782E+02 | 5.7288E−01 | −1.7850E+00 | 5.0696E+00 | −8.9909E+00 | 1.0430E+01 |
| R8 | −2.3344E+00 | 3.4786E−02 | 3.7025E−01 | −3.2145E+00 | 1.3600E+01 | −3.0082E+01 |
| R9 | −1.5663E+01 | 1.1221E−01 | −1.5199E−01 | −1.8779E+00 | 1.0517E+01 | −2.4678E+01 |
| R10 | −5.3166E+00 | 2.7258E−02 | −1.9564E−03 | 5.1329E−01 | −2.3631E+00 | 5.2920E+00 |
| R11 | −1.8712E+02 | 1.7700E−01 | 7.0871E−01 | −2.4955E+00 | 4.8979E+00 | −6.5133E+00 |
| R12 | −6.8259E−01 | 2.2056E+00 | −1.9723E+01 | 1.2687E+02 | −5.1768E+02 | 1.3383E+03 |
| R13 | −6.8259E−01 | 2.2056E+00 | −1.9723E+01 | 1.2687E+02 | −5.1768E+02 | 1.3383E+03 |
| R14 | −2.2058E+03 | −6.4765E−01 | 7.8005E+00 | −4.5625E+01 | 1.6880E+02 | −4.0352E+02 |

| | Conic Coefficient | Aspherical Coefficient | | | |
|---|---|---|---|---|---|
| | k | A14 | A16 | A18 | A20 |
| R3 | −1.0828E+02 | −3.6615E−01 | 1.1725E−01 | −2.1503E−02 | 1.7206E−03 |
| R4 | 1.8413E+00 | 5.2406E+02 | −5.2811E+02 | 2.9665E+02 | −7.1185E+01 |
| R5 | −3.6797E+00 | −4.7530E+02 | 4.9132E+02 | −2.7490E+02 | 6.2658E+01 |
| R6 | 2.3240E+01 | 1.3128E+02 | −1.1357E+02 | 5.4341E+01 | −1.1071E+01 |
| R7 | −1.2782E+02 | −8.3265E+00 | 4.6415E+00 | −1.6995E+00 | 3.0799E−01 |
| R8 | −2.3344E+00 | 3.9058E+01 | −2.9798E+01 | 1.2219E+01 | −2.0409E+00 |
| R9 | −1.5663E+01 | 3.2221E+01 | −2.4426E+01 | 1.0044E+01 | −1.7265E+00 |
| R10 | −5.3166E+00 | −7.1956E+00 | 5.8758E+00 | −2.6493E+00 | 5.1036E−01 |
| R11 | −1.8712E+02 | 5.5486E+00 | −2.7774E+00 | 6.2926E−01 | 0.0000E+00 |
| R12 | −6.8259E−01 | −2.1755E+03 | 2.1541E+03 | −1.1854E+03 | 2.7753E+02 |
| R13 | −6.8259E−01 | −2.1755E+03 | 2.1541E+03 | −1.1854E+03 | 2.7753E+02 |
| R14 | −2.2058E+03 | 6.2126E+02 | −5.9386E+02 | 3.2011E+02 | −7.4262E+01 |

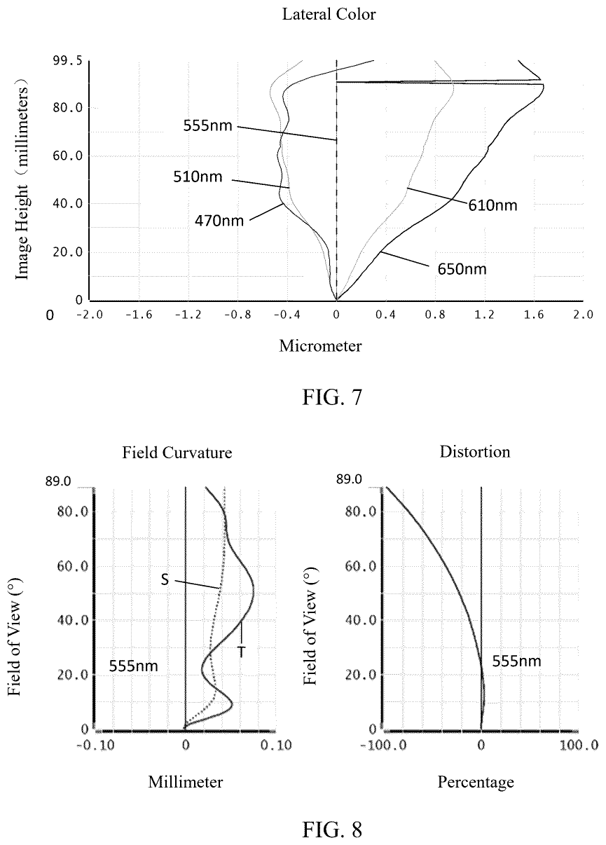

FIG. 6 and FIG. 7 respectively show longitudinal aberration and lateral color of light with wavelengths of 650 nm, 610 nm, 555 nm, 510 nm, and 470 nm after passing through the camera optical lens 20 according to Example 2. FIG. 8 shows field curvature and distortion of light with a wavelength of 555 nm after passing through the camera optical lens 20 according to Example 2. The field curvature S in FIG. 8 is the field curvature in the sagittal direction, and T is the field curvature in the meridian direction.

In this example, the entrance pupil diameter ENPD of the camera optical lens 20 is 0.549 mm, the full field of view (1.0 field of view) image height IH is 1.044 mm, and the field of view FOV in the diagonal direction of the full field of view (1.0 field of view) is 199.03°;

the camera optical lens 20 meets the design requirements of large aperture, wide-angle and ultra-thinness, and the on-axis and off-axis chromatic aberration thereof are fully corrected. The camera optical lens 20 has good optical characteristics.

### EXAMPLE 3

The meaning of the reference signs of Example 3 is the same as that of Example 1.

FIG. 9 shows a camera optical lens 30 according to Example 3 of the present disclosure.

Table 5 and Table 6 show design data of the camera optical lens 30 according to the Example 3 of the present disclosure.

TABLE 5

| | R | d | | nd | | νd | |
|---|---|---|---|---|---|---|---|
| S1 | ∞ | d0= | −4.512 | | | | |
| R1 | 7.477 | d1= | 0.848 | nd1 | 1.6516 | ν1 | 58.42 |
| R2 | 1.800 | d2= | 1.407 | | | | |
| R3 | −3.976 | d3= | 0.161 | nd2 | 1.5365 | ν2 | 55.98 |
| R4 | 1.591 | d4= | 0.748 | | | | |
| R5 | −6.747 | d5= | 1.284 | nd3 | 1.6610 | ν3 | 20.53 |
| R6 | −5.719 | d6= | 0.116 | | | | |
| R7 | −7.894 | d7= | 0.859 | nd4 | 1.5365 | ν4 | 55.98 |
| R8 | −1.441 | d8= | 0.020 | | | | |
| R9 | 2.578 | d9= | 1.145 | nd5 | 1.5365 | ν5 | 55.98 |
| R10 | −1.651 | d10= | 0.020 | | | | |
| R11 | −4.955 | d11= | 1.125 | nd6 | 1.5365 | ν6 | 55.98 |
| R12 | −0.615 | d12= | 0.000 | | | | |
| R13 | −0.615 | d13= | 0.312 | nd7 | 1.6610 | ν7 | 20.53 |
| R14 | −3.185 | d14= | 0.090 | | | | |
| R15 | ∞ | d15= | 0.210 | ndg | 1.5168 | νg | 64.17 |
| R16 | ∞ | d16= | 0.518 | | | | |

Table 6 shows aspherical surface data of each lens in the camera optical lens 30 according to Example 3 of the present disclosure.

TABLE 6

| | Conic Coefficient | Aspherical Coefficient | | | | |
|---|---|---|---|---|---|---|
| | k | A4 | A6 | A8 | A10 | A12 |
| R3 | −8.9254E+01 | 1.6644E−01 | −4.2264E−01 | 8.3853E−01 | −1.0602E+00 | 8.6329E−01 |
| R4 | 1.7501E+00 | −2.7124E−01 | 6.1488E+00 | −4.8041E+01 | 2.0892E+02 | −5.5672E+02 |
| R5 | 5.8189E+00 | −1.2381E−01 | −7.3427E−01 | 5.1345E+00 | −1.8690E+01 | 3.2186E+01 |
| R6 | 2.2959E+01 | 7.1559E−02 | 1.1439E+00 | −8.5375E+00 | 3.2973E+01 | −7.6087E+01 |
| R7 | −1.2850E+02 | 3.9622E−01 | −6.7216E−01 | 1.7747E+00 | −2.9875E+00 | 2.8912E+00 |
| R8 | −2.2903E+00 | 2.1534E−01 | −1.6696E+00 | 8.5139E+00 | −2.5165E+01 | 4.7919E+01 |
| R9 | −1.6260E+01 | 8.0696E−02 | −4.1793E−01 | 1.2558E+00 | −1.7646E+00 | 1.0104E+00 |
| R10 | −5.4708E+00 | 9.8216E−02 | −7.8276E−01 | 4.3936E+00 | −1.2641E+01 | 2.1157E+01 |
| R11 | −1.3700E+02 | 2.8537E−01 | −8.6889E−01 | 5.1839E+00 | −1.4855E+01 | 2.3063E+01 |
| R12 | −6.8310E−01 | 1.7196E+00 | −1.4934E+01 | 9.3940E+01 | −3.6786E+02 | 9.0865E+02 |
| R13 | −6.8310E−01 | 1.7196E+00 | −1.4934E+01 | 9.3940E+01 | −3.6786E+02 | 9.0865E+02 |
| R14 | −6.0214E+02 | −5.6918E−01 | 5.4146E+00 | −2.6431E+01 | 8.5887E+01 | −1.8460E+02 |

| | Conic Coefficient | Aspherical Coefficient | | | |
|---|---|---|---|---|---|
| | k | A14 | A16 | A18 | A20 |
| R3 | −8.9254E+01 | −4.4869E−01 | 1.4313E−01 | −2.5445E−02 | 1.9269E−03 |
| R4 | 1.7501E+00 | 9.2854E+02 | −9.4503E+02 | 5.3637E+02 | −1.2996E+02 |
| R5 | 5.8189E+00 | −8.1602E+00 | −5.7333E+01 | 8.2663E+01 | −3.5912E+01 |
| R6 | 2.2959E+01 | 1.0739E+02 | −9.1209E+01 | 4.2930E+01 | −8.6155E+00 |
| R7 | −1.2850E+02 | −1.6314E+00 | 5.6314E−01 | −1.4398E−01 | 2.7737E−02 |
| R8 | −2.2903E+00 | −5.8452E+01 | 4.4096E+01 | −1.8779E+01 | 3.4651E+00 |
| R9 | −1.6260E+01 | 4.3841E−01 | −1.0927E+00 | 6.6108E−01 | −1.3952E−01 |
| R10 | −5.4708E+00 | −2.1973E+01 | 1.4003E+01 | −5.0237E+00 | 7.7832E−01 |
| R11 | −1.3700E+02 | −2.0375E+01 | 9.5978E+00 | −1.8607E+00 | 0.0000E+00 |
| R12 | −6.8310E−01 | −1.4093E+03 | 1.3312E+03 | −6.9970E+02 | 1.5688E+02 |
| R13 | −6.8310E−01 | −1.4093E+03 | 1.3312E+03 | −6.9970E+02 | 1.5688E+02 |
| R14 | −6.0214E+02 | 2.5897E+02 | −2.2761E+02 | 1.1338E+02 | −2.4355E+01 |

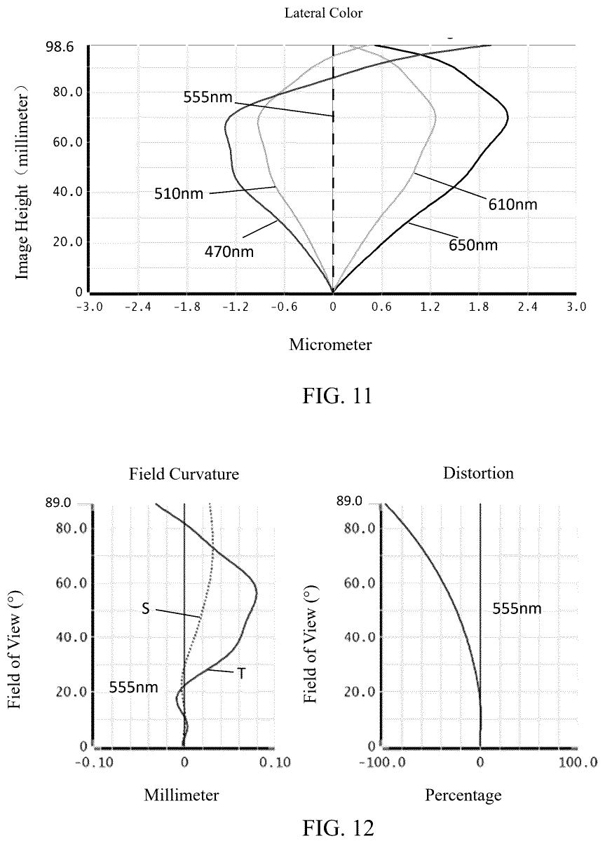

FIG. 10 and FIG. 11 respectively show longitudinal aberration and lateral color of light with wavelengths of 650 nm, 610 nm, 555 nm, 510 nm, and 470 nm after passing through the camera optical lens 30 according to Example 3. FIG. 12 shows field curvature and distortion of light with a wavelength of 555 nm after passing through the camera optical lens 30 according to Example 3. The field curvature S in FIG. 12 is the field curvature in the sagittal direction, and T is the field curvature in the meridian direction.

In this example, the entrance pupil diameter ENPD of the camera optical lens 30 is

0.599 mm, the full field of view (1.0 field of view) image height IH is 1.029 mm, and the field of view FOV in the diagonal direction of the full field of view (1.0 field of view) is 197.10°; the camera optical lens 30 meets the design requirements of large aperture, wide-angle and ultra-thinness, and the on-axis and off-axis chromatic aberration thereof are fully corrected. The camera optical lens 30 has good optical characteristics.

### EXAMPLE 4

The meaning of the reference signs of Example 4 is the same as that of Example 1.

FIG. 13 shows a camera optical lens 40 according to Example 4 of the present disclosure.

Table 7 and Table 8 show design data of the camera optical lens 40 according to Example 4 of the present disclosure.

TABLE 7

| | R | d | | nd | | νd | |
|---|---|---|---|---|---|---|---|
| S1 | ∞ | d0= | −4.460 | | | | |
| R1 | 7.708 | d1= | 0.757 | nd1 | 1.6516 | ν1 | 58.42 |
| R2 | 1.722 | d2= | 1.343 | | | | |
| R3 | −4.622 | d3= | 0.168 | nd2 | 1.5365 | ν2 | 55.98 |
| R4 | 1.579 | d4= | 0.811 | | | | |
| R5 | −7.338 | d5= | 1.320 | nd3 | 1.6610 | ν3 | 20.53 |
| R6 | −5.562 | d6= | 0.084 | | | | |
| R7 | −6.728 | d7= | 0.703 | nd4 | 1.5365 | ν4 | 55.98 |
| R8 | −1.813 | d8= | 0.020 | | | | |
| R9 | 1.930 | d9= | 0.741 | nd5 | 1.5365 | ν5 | 55.98 |
| R10 | −1.610 | d10= | 0.032 | | | | |
| R11 | −6.721 | d11= | 1.182 | nd6 | 1.5365 | ν6 | 55.98 |
| R12 | −0.606 | d12= | 0.000 | | | | |
| R13 | −0.606 | d13= | 0.334 | nd7 | 1.6610 | ν7 | 20.53 |
| R14 | −2.913 | d14= | 0.113 | | | | |
| R15 | ∞ | d15= | 0.210 | ndg | 1.5168 | νg | 64.17 |
| R16 | ∞ | d16= | 0.475 | | | | |

Table 8 shows aspherical surface data of each lens in the camera optical lens 40 according to Example 4 of the present disclosure.

TABLE 8

| | Conic Coefficient | Aspherical Coefficient | | | | |
|---|---|---|---|---|---|---|
| | k | A4 | A6 | A8 | A10 | A12 |
| R3 | −1.9086E+02 | 2.2396E−01 | −4.8887E−01 | 9.0488E−01 | −1.1309E+00 | 9.5240E−01 |
| R4 | 1.9756E+00 | −8.6346E−03 | 3.9422E+00 | −3.5082E+01 | 1.6243E+02 | −4.5417E+02 |
| R5 | 9.6623E+00 | 2.6134E−02 | −3.2896E+00 | 2.6813E+01 | −1.3011E+02 | 3.9269E+02 |
| R6 | 2.2673E+01 | 1.2423E−01 | 6.6860E−01 | −5.6251E+00 | 2.2561E+01 | −5.3219E+01 |
| R7 | −4.9985E+02 | 4.4233E−01 | −7.8989E−01 | 2.7450E+00 | −6.6052E+00 | 1.0436E+01 |
| R8 | −4.1119E+00 | 2.5575E−01 | −1.4968E+00 | 6.7163E+00 | −1.7190E+01 | 2.8433E+01 |
| R9 | −1.4793E+01 | 2.3140E−01 | −8.4555E−01 | 6.7828E−01 | 4.9734E+00 | −1.8174E+01 |
| R10 | −5.0812E+00 | 2.1967E−01 | −1.6945E+00 | 9.3345E+00 | −3.0648E+01 | 6.1455E+01 |
| R11 | −2.3709E+02 | 3.8227E−01 | −1.2546E+00 | 7.1343E+00 | −2.2824E+01 | 4.1672E+01 |
| R12 | −6.8420E−01 | 1.4062E+00 | −8.7358E+00 | 4.6260E+01 | −1.8132E+02 | 4.8985E+02 |
| R13 | −6.8420E−01 | 1.4062E+00 | −8.7358E+00 | 4.6260E+01 | −1.8132E+02 | 4.8985E+02 |
| R14 | −2.6011E+03 | −8.2638E−01 | 1.1216E+01 | −7.2602E+01 | 2.8804E+02 | −7.2373E+02 |

| | Conic Coefficient | Aspherical Coefficient | | | |
|---|---|---|---|---|---|
| | k | A14 | A16 | A18 | A20 |
| R3 | −1.9086E+02 | −5.3055E−01 | 1.8727E−01 | −3.7906E−02 | 3.3506E−03 |
| R4 | 1.9756E+00 | 7.8968E+02 | −8.3394E+02 | 4.8923E+02 | −1.2216E+02 |
| R5 | 9.6623E+00 | −7.4178E+02 | 8.5102E+02 | −5.4084E+02 | 1.4555E+02 |
| R6 | 2.2673E+01 | 7.5534E+01 | −6.3704E+01 | 2.9499E+01 | −5.7840E+00 |
| R7 | −4.9985E+02 | −1.1407E+01 | 8.4176E+00 | −3.7244E+00 | 7.2933E−01 |
| R8 | −4.1119E+00 | −2.9736E+01 | 1.8670E+01 | −6.3956E+00 | 9.3170E−01 |
| R9 | −1.4793E+01 | 2.8904E+01 | −2.4979E+01 | 1.1370E+01 | −2.1273E+00 |
| R10 | −5.0812E+00 | −7.6622E+01 | 5.7843E+01 | −2.4190E+01 | 4.3036E+00 |
| R11 | −2.3709E+02 | −4.4180E+01 | 2.5291E+01 | −6.0440E+00 | 0.0000E+00 |
| R12 | −6.8420E−01 | −8.5003E+02 | 8.9592E+02 | −5.1923E+02 | 1.2650E+02 |
| R13 | −6.8420E−01 | −8.5003E+02 | 8.9592E+02 | −5.1923E+02 | 1.2650E+02 |
| R14 | −2.6011E+03 | 1.1574E+03 | −1.1423E+03 | 6.3449E+02 | −1.5179E+02 |

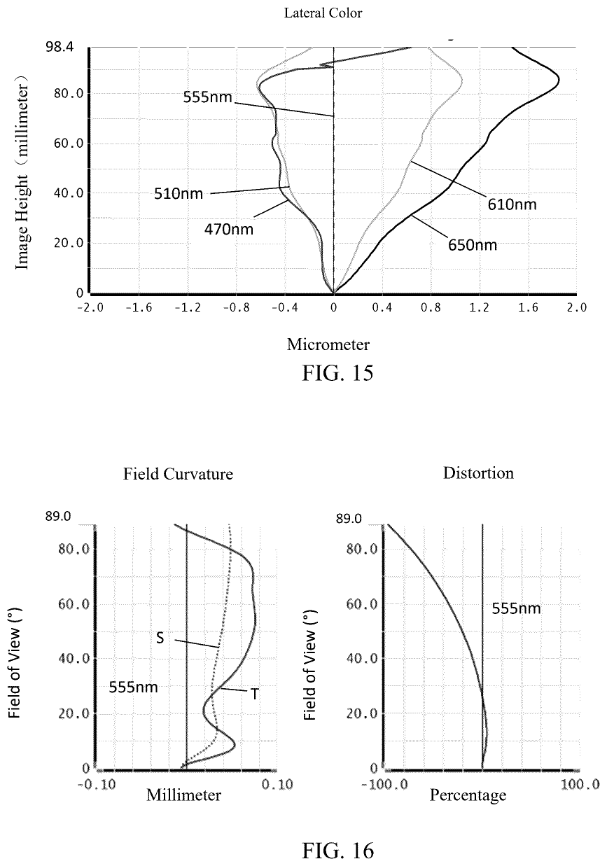

FIG. 14 and FIG. 15 respectively show longitudinal aberration and lateral color of light with wavelengths of 650 nm, 610 nm, 555 nm, 510 nm, and 470 nm after passing through the camera optical lens 40 according to Example 4. FIG. 16 shows field curvature and distortion of light with a wavelength of 555 nm after passing through the camera optical lens 40 according to Example 4. The field curvature S in FIG. 16 is the field curvature in the sagittal direction, and T is the field curvature in the meridian direction.

In this example, the entrance pupil diameter ENPD of the camera optical lens 40 is 0.496 mm, the full field of view (1.0 field of view) image height IH is 1.057 mm, and the field 10 of view FOV in the diagonal direction of the full field of view (1.0 field of view) is 196.86°; the camera optical lens 40 meets the design requirements of large aperture, wide-angle and ultra-thinness, and the on-axis and off-axis chromatic aberration thereof are fully corrected. The camera optical lens 40 has good optical characteristics.

### EXAMPLE 5

The meaning of the reference signs of Example 5 is the same as that of Example 1.

FIG. 17 shows a camera optical lens 50 according to Example 5 of the present disclosure.

Table 9 and Table 10 show design data of the camera optical lens 50 according to Example 5 of the present disclosure.

TABLE 9

| | R | d | | nd | | νd | |
|---|---|---|---|---|---|---|---|
| S1 | ∞ | d0= | −4.763 | | | | |
| R1 | 8.643 | d1= | 1.157 | nd1 | 1.6516 | ν1 | 58.42 |
| R2 | 1.873 | d2= | 1.173 | | | | |
| R3 | −4.165 | d3= | 0.239 | nd2 | 1.5365 | ν2 | 55.98 |
| R4 | 1.584 | d4= | 0.815 | | | | |
| R5 | −5.365 | d5= | 1.306 | nd3 | 1.6610 | ν3 | 20.53 |
| R6 | −5.931 | d6= | 0.102 | | | | |
| R7 | −7.004 | d7= | 0.653 | nd4 | 1.5365 | ν4 | 55.98 |
| R8 | −1.821 | d8= | 0.022 | | | | |
| R9 | 1.917 | d9= | 0.853 | nd5 | 1.5365 | ν5 | 55.98 |
| R10 | −1.569 | d10= | 0.048 | | | | |
| R11 | −7.282 | d11= | 1.152 | nd6 | 1.5365 | ν6 | 55.98 |
| R12 | −0.611 | d12= | 0.000 | | | | |
| R13 | −0.611 | d13= | 0.315 | nd7 | 1.6610 | ν7 | 20.53 |
| R14 | −2.980 | d14= | 0.093 | | | | |
| R15 | ∞ | d15= | 0.210 | ndg | 1.5168 | νg | 64.17 |
| R16 | ∞ | d16= | 0.514 | | | | |

Table 10 shows aspherical surface data of each lens in the camera optical lens 50 according to Example 5 of the present disclosure.

TABLE 10

| | Conic Coefficient | Aspherical Coefficient | | | | |
|---|---|---|---|---|---|---|
| | k | A4 | A6 | A8 | A10 | A12 |
| R3 | −9.2277E+01 | 1.8492E−01 | −3.8478E−01 | 6.3337E−01 | −7.0265E−01 | 5.2303E−01 |
| R4 | 1.8635E+00 | −1.1110E−02 | 3.0811E+00 | −2.5797E+01 | 1.1379E+02 | −3.0557E+02 |
| R5 | 5.8538E+00 | −8.0265E−02 | −1.5421E+00 | 1.2638E+01 | −5.9844E+01 | 1.7054E+02 |
| R6 | 2.4799E+01 | 1.0488E−01 | 9.8414E−01 | −9.1011E+00 | 3.7033E+01 | −8.4616E+01 |
| R7 | −1.6234E+02 | 5.7459E−01 | −2.1453E+00 | 8.1827E+00 | −2.1026E+01 | 3.7023E+01 |
| R8 | −2.5971E+00 | 1.3976E−01 | −8.9127E−01 | 4.6778E+00 | −1.4779E+01 | 3.1987E+01 |
| R9 | −1.4446E+01 | 1.4296E−01 | −5.0578E−01 | 1.5662E−01 | 4.4369E+00 | −1.3965E+01 |
| R10 | −5.0642E+00 | 1.5340E−01 | −1.0768E+00 | 5.3339E+00 | −1.5872E+01 | 2.9451E+01 |
| R11 | −1.4235E+02 | 3.0284E−01 | −3.5323E−01 | 1.6389E+00 | −4.8793E+00 | 7.8509E+00 |
| R12 | −6.5406E−01 | 1.4477E+00 | −1.2028E+01 | 7.4787E+01 | −2.9292E+02 | 7.2184E+02 |
| R13 | −6.5406E−01 | 1.4477E+00 | −1.2028E+01 | 7.4787E+01 | −2.9292E+02 | 7.2184E+02 |
| R14 | −1.6335E+03 | −6.4867E−01 | 7.5274E+00 | −4.4968E+01 | 1.7401E+02 | −4.3700E+02 |

| | Conic Coefficient | Aspherical Coefficient | | | |
|---|---|---|---|---|---|
| | k | A14 | A16 | A18 | A20 |
| R3 | −9.2277E+01 | −2.5634E−01 | 7.9165E−02 | −1.3943E−02 | 1.0667E−03 |
| R4 | 1.8635E+00 | 5.1248E+02 | −5.2337E+02 | 2.9745E+02 | −7.2061E+01 |
| R5 | 5.8538E+00 | −2.9231E+02 | 2.8789E+02 | −1.4323E+02 | 2.4696E+01 |
| R6 | 2.4799E+01 | 1.1520E+02 | −9.3225E+01 | 4.1515E+01 | −7.8477E+00 |
| R7 | −1.6234E+02 | −4.3889E+01 | 3.2989E+01 | −1.4049E+01 | 2.5652E+00 |
| R8 | −2.5971E+00 | −4.4585E+01 | 3.7795E+01 | −1.7740E+01 | 3.5488E+00 |
| R9 | −1.4446E+01 | 2.0537E+01 | −1.6682E+01 | 7.2006E+00 | −1.2857E+00 |
| R10 | −5.0642E+00 | −3.4728E+01 | 2.5202E+01 | −1.0250E+01 | 1.7898E+00 |
| R11 | −1.4235E+02 | −7.1866E+00 | 3.4454E+00 | −6.5081E−01 | 0.0000E+00 |
| R12 | −6.5406E−01 | −1.1019E+03 | 1.0060E+03 | −4.9986E+02 | 1.0307E+02 |
| R13 | −6.5406E−01 | −1.1019E+03 | 1.0060E+03 | −4.9986E+02 | 1.0307E+02 |
| R14 | −1.6335E+03 | 7.0478E+02 | −7.0180E+02 | 3.9154E+02 | −9.3420E+01 |

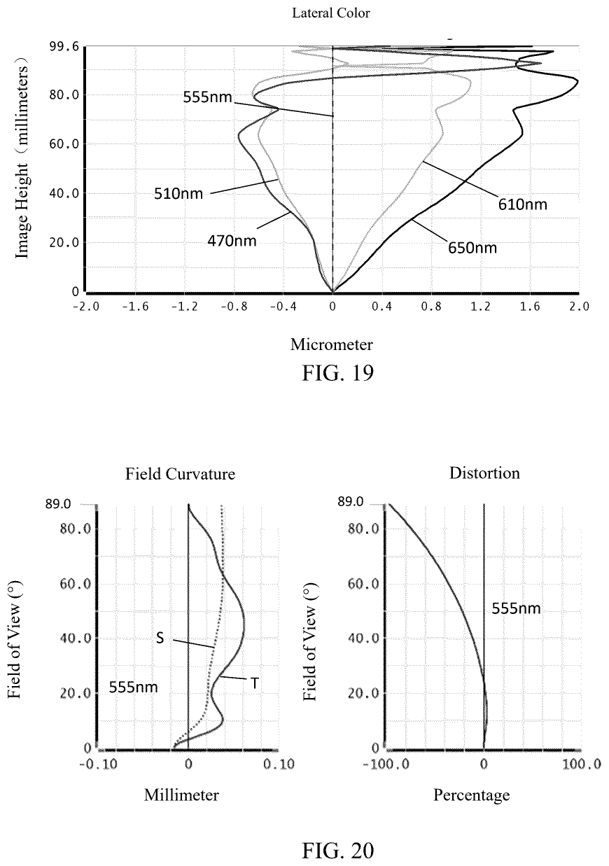

FIG. 18 and FIG. 19 respectively show longitudinal aberration and lateral color of light with wavelengths of 650 nm, 610 nm, 555 nm, 510 nm, and 470 nm after passing through the camera optical lens 50 according to Example 5. FIG. 20 shows field curvature and distortion of light with a wavelength of 555 nm after passing through the camera optical lens 50 according to Example 5. The field curvature S in FIG. 20 is the field curvature in the sagittal direction, and T is the field curvature in the meridian direction.

In this example, the entrance pupil diameter ENPD of the camera optical lens 50 is 0.544 mm, the full field of view (1.0 field of view) image height IH is 1.053 mm, and the field of view FOV in the diagonal direction of the full field of view (1.0 field of view) is 199.20°;

the camera optical lens 50 meets the design requirements of large aperture, wide-angle and ultra-thinness, and the on-axis and off-axis chromatic aberration thereof are fully corrected. The camera optical lens 50 has good optical characteristics.

### EXAMPLE 6

The meaning of the reference signs of Example 6 is the same as that of Example 1.

FIG. 21 shows a camera optical lens 60 according to Example 6 of the present disclosure.

Table 11 and Table 12 show design data of the camera optical lens 60 according to Example 6 of the present disclosure.

TABLE 11

| | R | d | | nd | | νd | |
|---|---|---|---|---|---|---|---|
| S1 | ∞ | d0= | −4.616 | | | | |
| R1 | 6.279 | d1= | 1.175 | nd1 | 1.6516 | ν1 | 58.42 |
| R2 | 1.729 | d2= | 1.117 | | | | |
| R3 | −5.121 | d3= | 0.168 | nd2 | 1.5365 | ν2 | 55.98 |
| R4 | 1.537 | d4= | 0.778 | | | | |
| R5 | −7.779 | d5= | 1.264 | nd3 | 1.6610 | ν3 | 20.53 |
| R6 | −5.629 | d6= | 0.140 | | | | |
| R7 | −7.297 | d7= | 0.710 | nd4 | 1.5365 | ν4 | 55.98 |
| R8 | −1.788 | d8= | 0.020 | | | | |
| R9 | 1.918 | d9= | 0.754 | nd5 | 1.5365 | ν5 | 55.98 |
| R10 | −1.603 | d10= | 0.066 | | | | |
| R11 | −6.076 | d11= | 1.118 | nd6 | 1.5365 | ν6 | 55.98 |
| R12 | −0.609 | d12= | 0.000 | | | | |
| R13 | −0.609 | d13= | 0.320 | nd7 | 1.6610 | ν7 | 20.53 |
| R14 | −3.498 | d14= | 0.086 | | | | |
| R15 | ∞ | d15= | 0.210 | ndg | 1.5168 | νg | 64.17 |
| R16 | ∞ | d16= | 0.501 | | | | |

Table 12 shows aspherical surface data of each lens in the camera optical lens 60

according to Example 6 of the present disclosure.

TABLE 12

| | Conic Coefficient | Aspherical Coefficient | | | | |
|---|---|---|---|---|---|---|
| | k | A4 | A6 | A8 | A10 | A12 |
| R3 | −1.0201E+02 | 1.5475E−01 | −3.2929E−01 | 5.7895E−01 | −6.6715E−01 | 4.9936E−01 |
| R4 | 1.6875E+00 | 1.9381E+00 | −2.4713E+01 | 1.8701E+02 | −8.5834E+02 | 2.4698E+03 |
| R5 | 2.1360E+00 | −4.6765E−01 | 4.6245E+00 | −3.9125E+01 | 2.0045E+02 | −6.4521E+02 |
| R6 | 2.2457E+01 | 1.7037E−01 | −9.3181E−02 | −9.2256E−01 | 4.8939E+00 | −1.1702E+01 |
| R7 | −1.2745E+02 | 5.1392E−01 | −1.5432E+00 | 5.0427E+00 | −1.0619E+01 | 1.4272E+01 |
| R8 | −2.2659E+00 | 7.0348E−02 | −3.3165E−01 | 1.5175E+00 | −2.6327E+00 | 2.5069E+00 |
| R9 | −1.5071E+01 | 1.2598E−01 | −7.2818E−01 | 2.3029E+00 | −4.0162E+00 | 4.3630E+00 |
| R10 | −5.3334E+00 | 5.7695E−02 | −2.5640E−01 | 1.2301E+00 | −3.0886E+00 | 4.4577E+00 |
| R11 | −2.4063E+02 | 3.3102E−01 | −7.3884E−01 | 3.7834E+00 | −1.0604E+01 | 1.6580E+01 |
| R12 | −6.7359E−01 | 1.4206E+00 | −1.3042E+01 | 7.9429E+01 | −2.8133E+02 | 6.1701E+02 |
| R13 | −6.7359E−01 | 1.4206E+00 | −1.3042E+01 | 7.9429E+01 | −2.8133E+02 | 6.1701E+02 |
| R14 | −7.6818E+01 | −5.0938E−01 | 6.9298E+00 | −4.4668E+01 | 1.7866E+02 | −4.4845E+02 |

| | Conic Coefficient | Aspherical Coefficient | | | |
|---|---|---|---|---|---|
| | k | A14 | A16 | A18 | A20 |
| R3 | −1.0201E+02 | −2.4003E−01 | 7.1279E−02 | −1.1872E−02 | 8.4713E−04 |
| R4 | 1.6875E+00 | −4.4794E+03 | 4.9720E+03 | −3.0848E+03 | 8.1986E+02 |
| R5 | 2.1360E+00 | 1.3066E+03 | −1.6117E+03 | 1.1040E+03 | −3.2160E+02 |
| R6 | 2.2457E+01 | 1.5356E+01 | −1.1498E+01 | 4.6320E+00 | −7.8054E−01 |
| R7 | −1.2745E+02 | −1.2197E+01 | 6.3543E+00 | −1.8095E+00 | 2.0846E−01 |
| R8 | −2.2659E+00 | −1.0011E+00 | −2.5065E−01 | 3.5909E−01 | −9.0672E−02 |
| R9 | −1.5071E+01 | −3.0376E+00 | 1.3048E+00 | −3.1275E−01 | 3.2336E−02 |
| R10 | −5.3334E+00 | −4.0168E+00 | 2.2397E+00 | −7.0943E−01 | 9.8123E−02 |
| R11 | −2.4063E+02 | −1.4953E+01 | 7.2862E+00 | −1.4875E+00 | 0.0000E+00 |
| R12 | −6.7359E−01 | −8.4663E+02 | 7.0747E+02 | −3.2923E+02 | 6.5486E+01 |
| R13 | −6.7359E−01 | −8.4663E+02 | 7.0747E+02 | −3.2923E+02 | 6.5486E+01 |
| R14 | −7.6818E+01 | 7.0954E+02 | −6.8725E+02 | 3.7197E+02 | −8.6127E+01 |

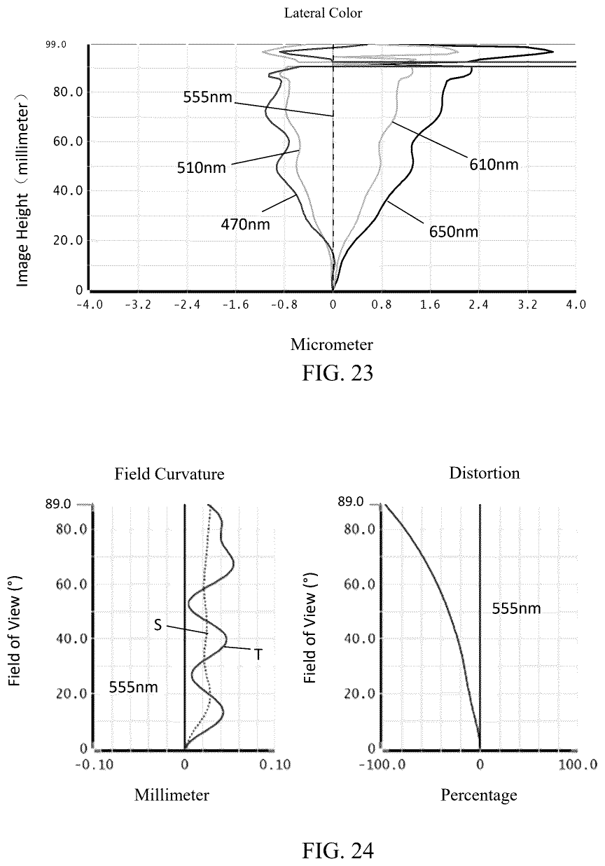

FIG. 22 and FIG. 23 respectively show longitudinal aberration and lateral color of light with wavelengths of 650 nm, 610 nm, 555 nm, 510 nm, and 470 nm after passing through the camera optical lens 60 according to Example 6. FIG. 24 shows field curvature and distortion of light with a wavelength of 555 nm after passing through the camera optical lens 60 according to Example 6. The field curvature S in FIG. 24 is the field curvature in a sagittal direction, and T is the field curvature in a meridian direction.

In this example, the entrance pupil diameter ENPD of the camera optical lens 60 is 0.686 mm, the full field of view (1.0 field of view) image height IH is 1.052 mm, and the field of view FOV in the diagonal direction of the full field of view (1.0 field of view) is 198.00°;

the camera optical lens 60 meets the design requirements of large aperture, wide-angle and ultra-thinness, and the on-axis and off-axis chromatic aberration thereof are fully corrected. The camera optical lens 60 has good optical characteristics.

### EXAMPLE 7

The meaning of the reference signs of Example 7 is the same as that of Example 1.

FIG. 25 shows a camera optical lens 70 according to Example 7 of the present disclosure.

Table 13 and Table 14 show design data of the camera optical lens 70 according to Example 7 of the present disclosure.

TABLE 13

| | R | d | | nd | | νd | |
|---|---|---|---|---|---|---|---|
| S1 | ∞ | d0= | −3.190 | | | | |
| R1 | 7.627 | d1= | 0.300 | nd1 | 1.6516 | ν1 | 58.42 |
| R2 | 1.771 | d2= | 0.604 | | | | |
| R3 | −4.665 | d3= | 0.175 | nd2 | 1.5365 | ν2 | 55.98 |
| R4 | 1.516 | d4= | 0.762 | | | | |
| R5 | −6.934 | d5= | 1.304 | nd3 | 1.6610 | ν3 | 20.53 |
| R6 | −5.659 | d6= | 0.075 | | | | |
| R7 | −6.427 | d7= | 0.630 | nd4 | 1.5365 | ν4 | 55.98 |
| R8 | −1.815 | d8= | 0.020 | | | | |
| R9 | 1.845 | d9= | 0.560 | nd5 | 1.5365 | ν5 | 55.98 |
| R10 | −1.658 | d10= | 0.029 | | | | |
| R11 | −6.359 | d11= | 1.117 | nd6 | 1.5365 | ν6 | 55.98 |
| R12 | −0.611 | d12= | 0.000 | | | | |
| R13 | −0.611 | d13= | 0.208 | nd7 | 1.6610 | ν7 | 20.53 |
| R14 | −3.073 | d14= | 0.188 | | | | |
| R15 | ∞ | d15= | 0.210 | ndg | 1.5168 | νg | 64.17 |
| R16 | ∞ | d16= | 0.616 | | | | |

Table 14 shows aspherical surface data of each lens in the camera optical lens 70 according to Example 7 of the present disclosure.

TABLE 14

| | Conic Coefficient | Aspherical Coefficient | | | | |
|---|---|---|---|---|---|---|
| | k | A4 | A6 | A8 | A10 | A12 |
| R3 | −1.1177E+02 | 3.4025E−01 | −8.8193E−01 | 2.0422E+00 | −3.2710E+00 | 3.4855E+00 |
| R4 | 2.0239E+00 | 1.6835E−01 | 2.3741E+00 | −2.6313E+01 | 1.3436E+02 | −4.0285E+02 |
| R5 | 2.9648E+01 | 4.0172E−02 | −3.9295E+00 | 3.2206E+01 | −1.6151E+02 | 5.1108E+02 |
| R6 | 2.3422E+01 | 2.0085E−01 | 3.5510E−01 | −8.0002E+00 | 3.6895E+01 | −8.5724E+01 |
| R7 | −1.2111E+02 | 6.7996E−01 | −1.8910E+00 | 1.2787E+00 | 1.0402E+01 | −3.4513E+01 |
| R8 | −2.2803E+00 | 3.5735E−01 | −2.3880E+00 | 9.2065E+00 | −2.1608E+01 | 3.4618E+01 |
| R9 | −1.6488E+01 | 3.0903E−01 | −2.1492E+00 | 7.0674E+00 | −1.3744E+01 | 1.8070E+01 |
| R10 | −5.4823E+00 | 5.6481E−02 | −3.2333E−01 | 1.9156E+00 | −5.3800E+00 | 8.7381E+00 |
| R11 | −1.6494E+02 | 2.2773E−01 | −3.3161E−02 | 1.5782E+00 | −6.5772E+00 | 1.1794E+01 |
| R12 | −6.6763E−01 | 2.5472E+00 | −1.9667E+01 | 1.1112E+02 | −4.1052E+02 | 9.8658E+02 |
| R13 | −6.6763E−01 | 2.5472E+00 | −1.9667E+01 | 1.1112E+02 | −4.1052E+02 | 9.8658E+02 |
| R14 | −5.1692E+02 | −4.7587E−01 | 4.3842E+00 | −2.1839E+01 | 7.3336E+01 | −1.6395E+02 |

| | Conic Coefficient | Aspherical Coefficient | | | |
|---|---|---|---|---|---|
| | k | A14 | A16 | A18 | A20 |
| R3 | −1.1177E+02 | −2.4006E+00 | 1.0248E+00 | −2.4608E−01 | 2.5375E−02 |
| R4 | 2.0239E+00 | 7.4163E+02 | −8.2326E+02 | 5.0496E+02 | −1.3127E+02 |
| R5 | 2.9648E+01 | −1.0245E+03 | 1.2627E+03 | −8.7351E+02 | 2.5958E+02 |
| R6 | 2.3422E+01 | 1.1512E+02 | −9.0954E+01 | 3.9405E+01 | −7.2397E+00 |
| R7 | −1.2111E+02 | 5.0662E+01 | −4.0712E+01 | 1.7456E+01 | −3.1434E+00 |
| R8 | −2.2803E+00 | −3.7429E+01 | 2.5916E+01 | −1.0293E+01 | 1.7660E+00 |
| R9 | −1.6488E+01 | −1.6558E+01 | 1.0060E+01 | −3.5828E+00 | 5.5909E−01 |
| R10 | −5.4823E+00 | −9.0988E+00 | 5.9841E+00 | −2.2460E+00 | 3.6454E−01 |
| R11 | −1.6494E+02 | −1.1539E+01 | 6.0824E+00 | −1.3607E+00 | 0.0000E+00 |
| R12 | −6.6763E−01 | −1.5233E+03 | 1.4526E+03 | −7.7599E+02 | 1.7720E+02 |
| R13 | −6.6763E−01 | −1.5233E+03 | 1.4526E+03 | −7.7599E+02 | 1.7720E+02 |
| R14 | −5.1692E+02 | 2.3631E+02 | −2.0904E+02 | 1.0260E+02 | −2.1294E+01 |

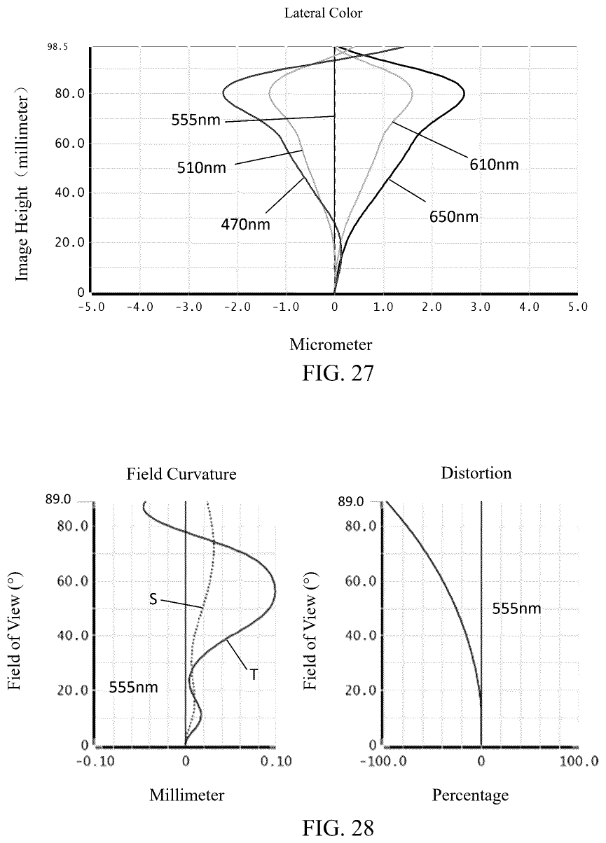

FIG. 26 and FIG. 27 respectively show longitudinal aberration and lateral color of light with wavelengths of 650 nm, 610 nm, 555 nm, 510 nm, and 470 nm after passing through the camera optical lens 70 according to Example 7. FIG. 28 shows field curvature and distortion of light with a wavelength of 555 nm after passing through the camera optical lens 70 according to Example 7. The field curvature S in FIG. 28 is the field curvature in a sagittal direction, and T is the field curvature in a meridian direction.

In this example, the entrance pupil diameter ENPD of the camera optical lens 70 is 0.618 mm, the full field of view (1.0 field of view) image height IH is 1.016 mm, and the field of view FOV in the diagonal direction of the full field of view (1.0 field of view) is 197.00°; the camera optical lens 70 meets the design requirements of large aperture, wide-angle and ultra-thinness, and the on-axis and off-axis chromatic aberration thereof are fully corrected. The camera optical lens 70 has good optical characteristics.

### Comparative Example

The meaning of the reference signs of Comparative Example is the same as that of Example 1.

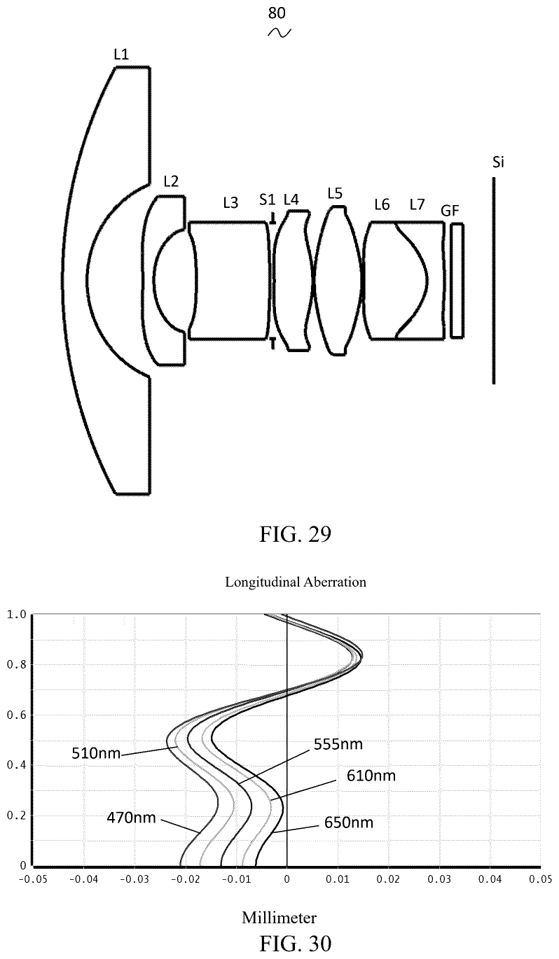

FIG. 29 shows a camera optical lens 80 according to Comparative Example in the present disclosure.

Table 15 and Table 16 show design data of the camera optical lens 80 according to Comparative Example in the present disclosure.

TABLE 15

| | R | d | | nd | | νd | |
|---|---|---|---|---|---|---|---|
| S1 | ∞ | d0= | −3.767 | | | | |
| R1 | 7.485 | d1= | 0.440 | nd1 | 1.6516 | ν1 | 58.42 |
| R2 | 1.775 | d2= | 1.001 | | | | |
| R3 | −4.311 | d3= | 0.198 | nd2 | 1.5365 | ν2 | 55.98 |
| R4 | 1.525 | d4= | 0.761 | | | | |
| R5 | −8.075 | d5= | 1.320 | nd3 | 1.6610 | ν3 | 20.53 |
| R6 | −5.493 | d6= | 0.075 | | | | |
| R7 | −6.412 | d7= | 0.692 | nd4 | 1.5365 | ν4 | 55.98 |
| R8 | −1.813 | d8= | 0.025 | | | | |
| R9 | 1.955 | d9= | 0.856 | nd5 | 1.5365 | ν5 | 55.98 |
| R10 | −1.613 | d10= | 0.034 | | | | |
| R11 | −6.364 | d11= | 1.134 | nd6 | 1.5365 | ν6 | 55.98 |
| R12 | −0.608 | d12= | 0.000 | | | | |
| R13 | −0.608 | d13= | 0.312 | nd7 | 1.6610 | ν7 | 20.53 |
| R14 | −3.044 | d14= | 0.121 | | | | |
| R15 | ∞ | d15= | 0.210 | ndg | 1.5168 | νg | 64.17 |
| R16 | ∞ | d16= | 0.549 | | | | |

Table 16 shows aspherical surface data of each lens in the camera optical lens 80 according to Comparative Example in the present disclosure.

TABLE 16

| | Conic Coefficient | Aspherical Coefficient | | | | |
|---|---|---|---|---|---|---|
| | k | A4 | A6 | A8 | A10 | A12 |
| R3 | −1.7164E+02 | 4.2403E−01 | −1.7887E+00 | 5.0923E+00 | −8.4459E+00 | 8.4341E+00 |
| R4 | 1.9711E+00 | 3.7343E−01 | 4.0684E+00 | −6.9283E+01 | 4.5327E+02 | −1.6327E+03 |
| R5 | 7.1696E+00 | −2.2351E−01 | 1.5438E+00 | −1.0349E+01 | 2.1277E+01 | 4.6580E+01 |
| R6 | 2.3499E+01 | 2.4491E−01 | −1.9141E+00 | 1.4632E+01 | −6.1434E+01 | 1.4881E+02 |
| R7 | −1.1091E+02 | 4.0269E−01 | −4.6254E−01 | 9.3414E−01 | −2.7813E+00 | 6.4718E+00 |
| R8 | −2.1643E+00 | 3.3702E−02 | 2.5233E−01 | −1.3395E+00 | 4.8119E+00 | −9.8342E+00 |
| R9 | −1.6061E+01 | 1.2537E−01 | −5.7693E−01 | 1.7784E+00 | −3.7704E+00 | 5.7104E+00 |
| R10 | −5.5576E+00 | 5.5658E−02 | −1.5999E−01 | 1.0161E+00 | −3.6464E+00 | 7.3105E+00 |
| R11 | −1.4286E+02 | 2.4279E−01 | 2.9072E−01 | −2.8766E+00 | 1.0996E+01 | −2.2262E+01 |
| R12 | −6.9420E−01 | 8.6724E−01 | 3.8693E+00 | −5.9872E+01 | 3.2034E+02 | −9.2175E+02 |
| R13 | −6.9420E−01 | 8.6724E−01 | 3.8693E+00 | −5.9872E+01 | 3.2034E+02 | −9.2175E+02 |
| R14 | −2.0977E+02 | −2.0433E−01 | 1.7297E−01 | 1.4660E+01 | −1.0110E+02 | 3.1479E+02 |

| | Conic Coefficient | Aspherical Coefficient | | | |
|---|---|---|---|---|---|
| | k | A14 | A16 | A18 | A20 |
| R3 | −1.7164E+02 | −5.1526E+00 | 1.8867E+00 | −3.8053E−01 | 3.2531E−02 |
| R4 | 1.9711E+00 | 3.4721E+03 | −4.3320E+03 | 2.9297E+03 | −8.2863E+02 |
| R5 | 7.1696E+00 | −3.2065E+02 | 6.5339E+02 | −6.0916E+02 | 2.2095E+02 |
| R6 | 2.3499E+01 | −2.1661E+02 | 1.8729E+02 | −8.8696E+01 | 1.7721E+01 |
| R7 | −1.1091E+02 | −9.0538E+00 | 7.2168E+00 | −3.0299E+00 | 5.1761E−01 |
| R8 | −2.1643E+00 | 1.2488E+01 | −9.6413E+00 | 4.1193E+00 | −7.4800E−01 |
| R9 | −1.6061E+01 | −5.8234E+00 | 3.7136E+00 | −1.3312E+00 | 2.0496E−01 |
| R10 | −5.5576E+00 | −8.7452E+00 | 6.1646E+00 | −2.3618E+00 | 3.7965E−01 |
| R11 | −1.4286E+02 | 2.4529E+01 | −1.3953E+01 | 3.2047E+00 | 0.0000E+00 |
| R12 | −6.9420E−01 | 1.5390E+03 | −1.4881E+03 | 7.7402E+02 | −1.6781E+02 |
| R13 | −6.9420E−01 | 1.5390E+03 | −1.4881E+03 | 7.7402E+02 | −1.6781E+02 |
| R14 | −2.0977E+02 | −5.3313E+02 | 5.0593E+02 | −2.5255E+02 | 5.1508E+01 |

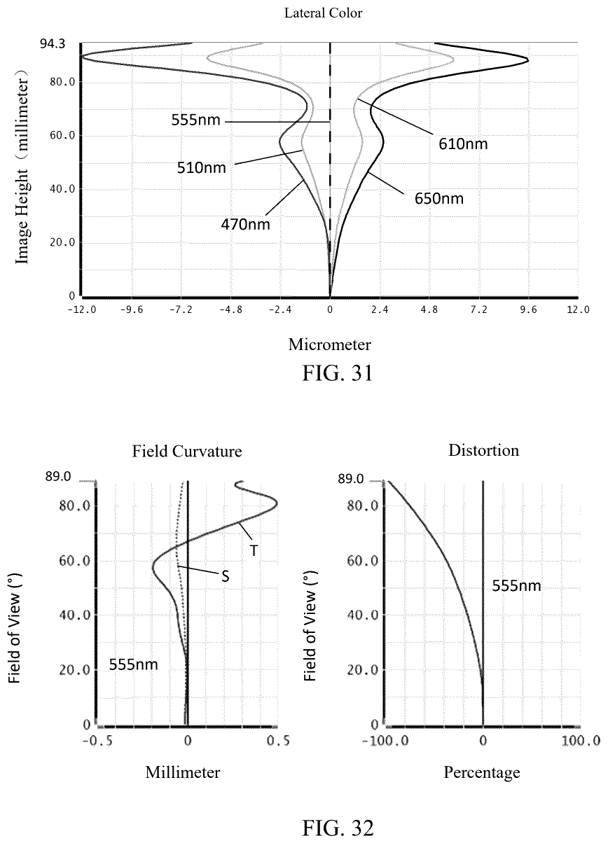

FIG. 30 and FIG. 31 respectively show longitudinal aberration and lateral color of light with wavelengths of 650 nm, 610 nm, 555 nm, 510 nm, and 470 nm after passing through the camera optical lens 80 according to Comparative Example. FIG. 32 shows field curvature and distortion of light with a wavelength of 555 nm after passing through the camera optical lens 80 according to Comparative Example. The field curvature S in FIG. 32 is the field curvature in a sagittal direction, and Tis the field curvature in a meridian direction.

In Comparative Example, the entrance pupil diameter ENPD of the camera optical lens 80 is 0.600 mm, the full field of view (1.0 field of view) image height IH is 1.050 mm, and the field of view FOV in the diagonal direction of the full field of view (1.0 field of view) is 188.69°; in the camera optical lens 80, R5/R6=1.47, 0.90≤R5/R6≤1.40 is not satisfied, it does not meet the design requirements of large aperture, wide-angle and ultra-thinness, and the on-axis and off-axis chromatic aberration thereof are not fully corrected. The camera optical lens 80 does not has good optical characteristics.

TABLE 17

| Parameters | | | | | | | | |
|---|---|---|---|---|---|---|---|---|
| and | | | | | | | | |
| Relational | Example | Example | Example | Example | Example | Example | Example | Comparative |
| Expressions | 1 | 2 | 3 | 4 | 5 | 6 | 7 | Example |
| f4/f5 | 2.49 | 3.39 | 1.52 | 2.50 | 2.50 | 2.40 | 2.61 | 2.49 |
| R5/R6 | 1.27 | 1.26 | 1.18 | 1.32 | 0.90 | 1.38 | 1.23 | 1.47 |
| FOV/Fno | 191.51 | 181.94 | 184.64 | 170.75 | 181.98 | 199.51 | 184.53 | 179.58 |
| v6-v7 | 35.45 | 35.45 | 35.45 | 35.45 | 35.45 | 35.45 | 35.45 | 35.45 |
| BF/TTL | 0.11 | 0.09 | 0.09 | 0.10 | 0.09 | 0.09 | 0.15 | 0.11 |
| \|f2/d3\| | 10.21 | 12.98 | 12.95 | 12.93 | 8.80 | 12.95 | 12.00 | 10.44 |
| f | 0.646 | 0.600 | 0.639 | 0.572 | 0.595 | 0.681 | 0.660 | 0.63 |
| f1 | −3.721 | −3.703 | −3.856 | −3.570 | −3.922 | −4.066 | −3.601 | −3.673 |
| f2 | −2.087 | −2.185 | −2.090 | −2.166 | −2.102 | −2.178 | −2.105 | −2.068 |
| f3 | 28.931 | 30.317 | 37.531 | 26.570 | −1113.63 | 24.737 | 32.762 | 21.386 |
| f4 | 4.462 | 5.633 | 3.130 | 4.392 | 4.380 | 4.210 | 4.483 | 4.461 |
| f5 | 1.794 | 1.659 | 2.065 | 1.760 | 1.753 | 1.754 | 1.718 | 1.793 |
| f6 | 1.158 | 1.157 | 1.196 | 1.160 | 1.172 | 1.174 | 1.177 | 1.168 |
| f7 | −1.180 | −1.191 | −1.202 | −1.219 | −1.228 | −1.158 | −1.185 | −1.201 |
| Fno | 1.029 | 1.094 | 1.067 | 1.153 | 1.095 | 0.992 | 1.068 | 1.051 |
| TTL | 7.872 | 8.910 | 8.863 | 8.293 | 8.652 | 8.427 | 6.798 | 7.728 |

Those skilled in the art may understand that the above examples are specific embodiments for implementing the present disclosure, and in practical applications, various changes may be made in form and detail without departing from the spirit and scope of the present disclosure.

What is claimed is:

1. A camera optical lens, sequentially comprising seven lenses from an object side to an image side: a first lens having negative refractive power, a second lens having negative refractive power, a third lens having refractive power, a fourth lens having positive refractive power, a fifth lens having positive refractive power, a sixth lens having positive refractive power, and a seventh lens having negative refractive power;
wherein, a focal length of the fourth lens is f4, a focal length of the fifth lens is f5, a central curvature radius of an object side surface of the third lens in a paraxial region is R5, a central curvature radius of an image side surface of the third lens in the paraxial region is R6, a field of view of 1.0 field of view of the camera optical lens is FOV, and an aperture value of the camera optical lens is Fno, and following relational expressions are satisfied:
$$0. 50 \leq f 4 / f 5 \leq 3.4 ; \\ 0.9 \leq R 5 / R 6 \leq 1.4 ; \\ and \\ 170. \leq FOV / Fno \leq 200.00 .$$

2. The camera optical lens as described in claim 1, wherein an abbe number of the sixth lens is v6, and an abbe number of the seventh lens is v7, and a following relational expression is satisfied:
$$v 6 - v 7 \geq 35. .$$

3. The camera optical lens as described in claim 1, wherein an on-axis distance from an image side surface of the seventh lens to an image plane is BF; a total optical length from an object side surface of the first lens to an image plane of the camera optical lens along an optic axis is TTL, and a following relational expression is satisfied:
$$0.09 \leq BF / TTL \leq 0.15 .$$

4. The camera optical lens as described in claim 1, wherein a focal length of the second lens is f2, an on-axis thickness of the second lens is d3, and a following relational expression is satisfied:
$$8.8 \leq \vert f 2 / d 3 \vert \leq 13. .$$

5. The camera optical lens as described in claim 1, wherein an object side surface of the first lens is convex in a paraxial region, and an image side surface of the first lens is concave in the paraxial region;
a focal length of the camera optical lens is f, a focal length of the first lens is f1, a central curvature radius of the object side surface of the first lens in a paraxial region is R1, a central curvature radius of the image side surface of the first lens in the paraxial region is R2, an on-axis thickness of the first lens is d1, and the total optical length from the object side surface of the first lens to an image plane of the camera optical lens along an optic axis is TTL, and following relations are satisfied:
$$- 13.18 \leq f 1 / f \leq - 3.84 ; \\ 0.75 \leq ( R 1 + R 2 ) / ( R 1 - R 2 ) \leq 2.64 ; \\ and \\ 0.02 \leq d 1 / TTL \leq 0.24 .$$

6. The camera optical lens as described in claim 1, wherein an object side surface of the second lens is concave in a paraxial region, and an image side surface of the second lens is concave in the paraxial region;
the focal length of the camera optical lens is f, a focal length of the second lens is f2, a central curvature radius of an object side surface of the second lens in a paraxial region is R3, a central curvature radius of an image side surface of the second lens in the paraxial region is R4, an on-axis thickness of the second lens is d3, and the total optical length from the object side surface of the first lens to an image plane of the camera optical lens along an optic axis is TTL, and following relational expressions are satisfied:
$$- 7.57 \leq f 2 / f \leq - 2 \text{.15} ; \\ 0.21 \leq ( R 3 + R 4 ) / ( R 3 - R 4 ) \leq 0.74 ; \\ and \\ 0.01 \leq d 3 / TTL \leq 0.04 .$$

7. The camera optical lens as described in claim 1, wherein the object side surface of the third lens is concave in a paraxial region, and an image side surface of the third lens is convex in the paraxial region;
the focal length of the camera optical lens is f, a focal length of the third lens is f3, an on-axis thickness of the third lens is d5, and the total optical length from the object side surface of the first lens to an image plane of the camera optical lens along an optic axis is TTL, and following relational expressions are satisfied:
$$- 3 743.34 \leq f 3 / f \leq 88.1 ; \\ - 39.92 \leq ( R 5 + R 6 ) / ( R 5 - R 6 ) \leq 18.19 ; \\ 0.07 \leq d 5 / TTL \leq 0.25 .$$

8. The camera optical lens as described in claim 1, wherein an object side surface of the fourth lens is concave in a paraxial region, and an image side surface of the fourth lens is convex in the paraxial region;
the focal length of the camera optical lens is f, a central curvature radius of an object side surface of the fourth lens in a paraxial region is R7, a central curvature radius of an image side surface of the fourth lens in the paraxial region is R8, an on-axis thickness of the fourth lens is d7, and the total optical length from the object side surface of the first lens to an image plane of the camera optical lens along an optic axis is TTL, and the following relational expressions are satisfied:
$$2.45 \leq f 4 / f \leq 14.08 ; \\ 0.72 \leq ( R 7 + R 8 ) / ( R 7 - R 8 ) \leq 3.62 ; \\ and \\ 0 \text{.03} \leq d 7 / TTL \leq 0.15 .$$

9. The camera optical lens as described in claim 1, wherein an object side surface of the fifth lens is convex in a paraxial region, an image side surface of the fifth lens is convex in the paraxial region;
a focal length of the camera optical lens is f, a central curvature radius of an object side surface of the fifth lens in a paraxial region is R9, a central curvature radius of an image side surface of the fifth lens in the paraxial region is R10, an on-axis thickness of the fifth lens is d9, and a total optical length from the object side surface of the first lens to an image plane of the camera optical lens along an optic axis is TTL, and following relational expressions are satisfied:
$$1.29 \leq f 5 / f \leq 4.85 ; \\ 0.03 \leq ( R 9 + R 10 ) / ( R 9 - R 10 ) \leq 0.33 ; \\ and \\ 0.04 \leq d 9 / TTL \leq 0.19 .$$

10. The camera optical lens as described in claim 1, wherein the first lens is made of glass.
